(19) United States
(12) Patent Application Publication
(10) Pub. No.: US 2004/0030531 A1
(43) Pub. Date: Feb. 12, 2004

(54) System and method for automated monitoring, recognizing, supporting, and responding to the behavior of an actor

(75) Inventors: Christopher A. Miller, St. Paul, MN (US); Wende L. Dewing, Minneapolis, MN (US); Karen Z. Haigh, Greenfield, MN (US); David C. Toms, Minneapolis, MN (US); Rand P. Whillock, North Oaks, MN (US); Christopher W. Geib, Minneapolis, MN (US); Stephen V. Metz, St. Paul, MN (US); Rose Mae M. Richardson, Roseville, MN (US); Stephen D. Whitlow, Rogers, MN (US); John A. Allen, New Brighton, MN (US); Lawrence A. King, Minneapolis, MN (US); John A. Phelps, Newport, ME (US); Victor A. Riley, Shoreview, MN (US); Peggy Wu, Minneapolis, MN (US)

Correspondence Address: DICKE, BILLIG & CZAJA, 701 Building, Suite 1250, 701 Fourth Avenue South, Minneapolis, MN, 55415, US

(73) Assignee: Honeywell International Inc.

(21) Appl. No.: 10/341,335

(22) Filed: Jan. 10, 2003

Related U.S. Application Data
(60) Provisional application No. 60/368,307, filed on Mar. 28, 2002.

(51) Int. Cl. G06F 11/30; G06F 15/00; G21C 17/00

(52) U.S. Cl. 702/182

(57) ABSTRACT

An automated system and method for monitoring and supporting and actor in an environment, such as a daily living environment. The system includes at least one sensor, at least one effector and a controller adapted to provide monitoring, situation assessment, response planning, and plan execution functions. In one preferred embodiment, the controller provides a layered architecture allowing multiple modules to interact and perform the desired monitoring and support functions.

### CROSS-REFERENCE TO RELATED APPLICATIONS

This application is related to, and is entitled to the benefit of, U.S. Provisional Patent Application Serial No. 60/351,300, filed Jan. 22, 2002; U.S. Provisional Patent Application Serial No. 60/368,307, filed Mar. 28, 2002; U.S. Provisional Patent Application Serial No. 60/384,899, filed May 30, 2002; and U.S. Provisional Patent Application Serial No. 60/384,519, filed May 29, 2002; U.S. patent application Ser. No. 10/286,398, filed on Nov. 1, 2002; U.S. Provisional Patent Application Serial No. 60/424,257, filed on Nov. 6, 2002; a U.S. non-provisional patent application filed on even date herewith, entitled “System and Method for Learning Patterns of Behavior and Operating a Monitoring and Response System Based Thereon”, having attorney docket number H0003384.02; a U.S. provisional patent application filed on even date herewith, entitled “System and Method for Automatically Generating an Alert Message with Supplemental Information”, having attorney docket number H0003365; the teachings of all of which are incorporated herein by reference.

### BACKGROUND OF THE INVENTION

The present invention relates to an automated system and method for providing assistance to individuals based, at least in part, upon monitored activities. More particularly, it relates to a system and method that intelligently monitors, recognizes, supports, and responds to activities of an individual in an environment such as an in-home, daily living environment.

The evolution of technology has given rise to numerous, discrete devices adapted to make daily, in-home living more convenient. For example, companies are selling microwaves that connect to the Internet, and refrigerators with computer displays, to name but a few. Manufacturers have thus far concentrated on the devices themselves, and the network protocols necessary for them to communicate on an individual basis. Experience in other domains (e.g., avionics, oil refineries, surgical theaters, etc.) shows that such innovations will merely produce a collection of distributed devices with localized intelligence that are not integrated, and that may actually conflict with each other in their installation and operation. Further, these discrete products typically include highly advanced sensor technology, and thus are quite expensive. Taken as a whole, then, these technological advancements are ill-suited to provide coordinated, situation aware, universal support to an in-home resident on a cost-effective basis.

The above-described drawbacks associated with state-of-the-art home-related technology are highly problematic in that a distinct need exists for an integrated personal assistant system. One particular population demographic evidencing a clear desire for such a system is elderly individuals. Generally speaking, with advanced age, elderly individuals may experience difficulties in safely taking care of themselves. Apparently, a nursing home is often the only option, in spite of the financial and emotional strain placed on both the individual as well as his/her family. Similar concerns arise for a number of other population categories, such as persons with specific disease conditions (e.g., dementia, Alzheimer's, etc.), disabled people, children, teenagers, over-stressed single parents, hospitals (e.g., newborns, general patient care, patient location/wandering, etc.), low-security prisons, or persons on parole. Other types of persons that could benefit from varying degrees of in-home or institutional monitoring and assistance include the mentally disabled, depressed or suicidal individuals, recovering drug or alcohol addicts, etc. In fact, virtually anyone could benefit from a universal system adapted to provide general in-home monitoring, reminding, integration, and management of in-home automation devices (e.g., integration of home comfort devices, vacation planning, food ordering, etc.), etc.

Some efforts have been made to develop a daily living monitoring system based upon information obtained by one or more sensors disposed about the user's home. For example, U.S. Pat. No. 5,692,215 and U.S. Pat. No. 6,108,685, both to Kutzik et al., describe an in-home monitoring and data-reporting device geared to generate movement, toileting, and medication-taking data for the elderly. The Kutzik et al. system cannot independently determine appropriate actions based upon sensor data; instead, the data is simply forwarded onto a caregiver who must independently analyze the information, formulate a response and execute the response at a later point in time. The recognition by Kutzik that monitoring a person's daily living activities can provide useful information for subsequently assisting that person is clearly a step in the right direction. However, to be truly beneficial, an appropriate personal, in-home assistant system must not only receive sensor data, but also integrates these individual functions and information sources to automatically develop an appropriate response plan and implement the plan, thereby greatly assisting the actor/user in their activities. A trend analysis feature alluded to by Kutzik et al. may provide a separate person (i.e., caregiver) with data from which a possible course of action could be gleaned. However, the Kutzik et al. system itself does not provide any in-depth sensor information correlation or analysis, and cannot independently or immediately assess a particular situation being encountered by the user, let alone generate an automated, situation-appropriate response. Further, Kutzik et al., does not address the “technophobia” concerns (often associated with elderly individuals) that might otherwise impede complete interaction between the user and the system. The inability of Kutzik, as well as other similar systems, to satisfy these constraints is not surprising, given that requisite system architecture, ontology and methodologies did not heretofore exist and the system needs to overcome extensive technology and logic or reasoning obstacles.

Emerging sensing and automation technologies represent an exciting opportunity to develop a system to monitor and support an actor in an environment. Unfortunately, current techniques entail either discrete devices that are unable to interact with one another and/or cannot independently and automatically respond to the daily activities of an actor based upon sensor-provided information. Therefore, a need exists for a system and method for providing accurate situation assessment and appropriate, intelligent responsive plan generation and implementation based upon the sensed daily activities of an actor.

### BRIEF DESCRIPTION OF THE DRAWINGS

FIG. 1 is a block diagram illustrating the system of the present invention;

FIG. 2 is a simplified, schematic diagram of an architectural configuration of the system of FIG. 1;

FIG. 3 is a schematic illustration of a preferred architectural configuration of the system of FIG. 1;

FIGS. 4-11 are schematic illustrations of alternative architectural configurations;

FIG. 12 is a block diagram of an alternative system in accordance with the present invention;

FIGS. 13A-13C provide an exemplary method of operation in accordance with the present invention in flow diagram form;

FIG. 14 is a schematic illustration of an architecture associated with the method of FIGS. 13A-13C; and

FIGS. 14-21 are block diagrams of alternative system configurations in accordance with the present invention.

### DETAILED DESCRIPTION OF THE PREFERRED EMBODIMENTS

A. Hardware Overview

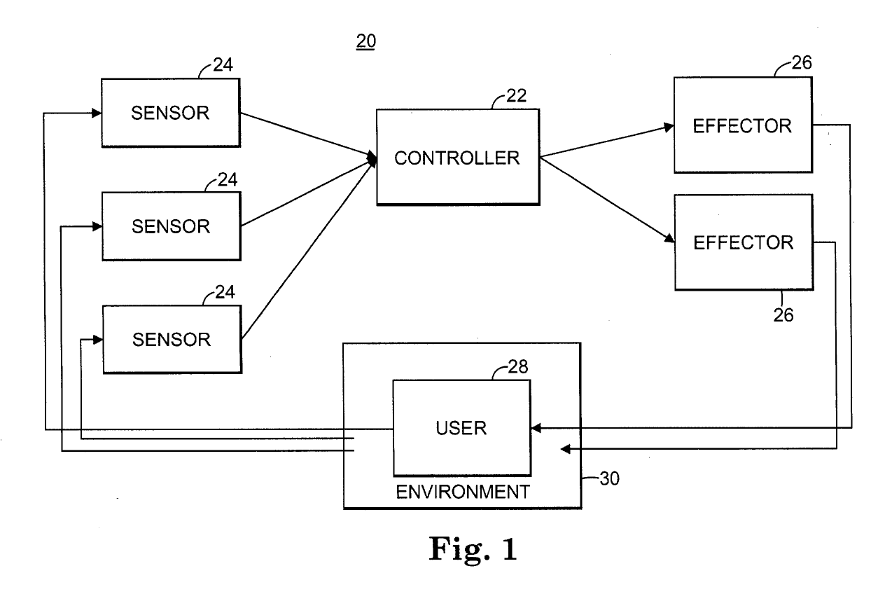

One preferred embodiment of an actor (or user or client) monitoring and responding system 20 in accordance with the present invention is shown in block form in FIG. 1. As a point of reference, the system 20 offers the potential to incorporate monitoring and support tools as a personal assistant. By providing intelligent, affordable, usable, and expandable integration of devices, the system 20 will support daily activities, facilitate remote interaction with family and caregivers, provide safety and security, and otherwise assist the user.

In most general terms, the system 20 includes one or more controllers 22, a plurality of sensors 24, and one or more effectors 26. As described in greater detail below, the sensors 24 actively and/or passively monitor daily activities of an actor or user 28 or their environment (including other humans, animals, etc.). Information or data from the sensors 24 is signaled to the controller 22. The controller 22 processes the received information and, in conjunction with architecture features described below, assesses the actor's 28 actions or situation (or the actor's 28 environment 30), and performs a response planning task in which an appropriate response based upon the assessed situation is generated. Based upon this selected response, the controller 22 signals the effector 26 that in turn carries out the planned response relative to the actor 28 or any other interested party (or caregiver) depending upon the particular situation. As used throughout the specification, the term “caregiver” encompasses any human other than the actor 28 that is in the actor's environment 30 or interacts with the actor 28 for any reason. Thus, a “caregiver” in accordance with the present invention is not limited to a medical specialist (e.g., physician or nurse), but further includes any human such as a relative, neighbor, guest, etc. Further, the term “environment” encompasses a physical structure in which the actor 28 is located (permanently or periodically) as well as all things in that physical structure, such as lights, plumbing, ventilation, appliances, humans other than the actor 28 that at least periodically visit (e.g., caregiver as defined above and pets), etc.

The key component associated with the system 20 resides in the architecture provided with the controller 22. As such, the sensors 24 and the effectors 26 can assume a wide variety of forms. Preferably, the sensors 24 are low cost, and are networked by the controller 22. For example, the sensors 24 can include motion detectors, pressure pads, door latch sensors, panic buttons, toilet-flush sensors, microphones, cameras, fall-sensors, door sensors, heart rate monitor sensors, blood pressure monitor sensors, glucose monitor sensors, moisture sensors, light level sensors, telephone sensors, smoke/fire detectors, thermal sensors, water sensors, seismic sensors, etc. In addition, one or more of the sensors 24 can be a sensor or actuator associated with a device or appliance used by the actor 28, such as a stove, oven, television, telephone, security pad, medication dispenser, thermostat, etc., with the sensor or actuator providing data indicating that the device or appliance is being operated by the actor 28 (or someone else). The sensors 24 can be non-intrusive or intrusive, active or passive, wired or wireless, physiological or physical. In short, the sensors 24 can include any type of sensor that provides information relating to activities or status of the actor 28 or the environment.

Similarly, the effectors 26 can also assume a wide variety of forms. Examples of applicable effectors 26 include computers, displays, telephones, pagers, speaker systems, lighting systems, fire sprinkler, door lock devices, pan/tilt/zoom controls on a camera, etc. The effectors 26 can be placed directly within the actor's 28 environment, and/or can be remote from the actor 28, for example providing information to other persons concerned with the actor's 28 daily activities (e.g., caregiver, family members, etc.).

The controller 22 is preferably a microprocessor-based device capable of storing and operating appropriate architectural components (or other modules), as described below. In this regard, the controller 22 can include discrete components that are linked to one another for appropriate interface. For example, a first controller component can be located at the actor's 28 home, whereas a second controller component can be located off-site. Alternatively, an even greater number of controller components can be provided. Conversely, an entirety of the controller 22 can be located on-site or off-site, or can be worn on the body of the actor 28. Various hardware configuration for the controller 28 are described in greater detail elsewhere.

B. Architecture and Related Functions

As previously described, the ability of the system 20 of the present invention to provide integration of the various sensor data in conjunction with intelligent formulation of an appropriate response to a particular situation encountered by the actor 28 resides in the architecture provided with the controller 22. The architecture configuration for accomplishing these goals can reside in various iterations that are dependent upon a particular installation; a more complex application will entail a more complex architectural arrangement in terms of availability and integration of additional features. Regardless, to best explain the various architecture and preferred features/configurations, the foregoing description includes exemplary hypothetical situations in conjunction with the methodology that the feature/configuration being described would employ to sense, analyze and/or address the hypothetical. The examples provided are in no way limiting of the countless potential applications for the system 20 architecture, and the listed responses are in no way exhaustive.

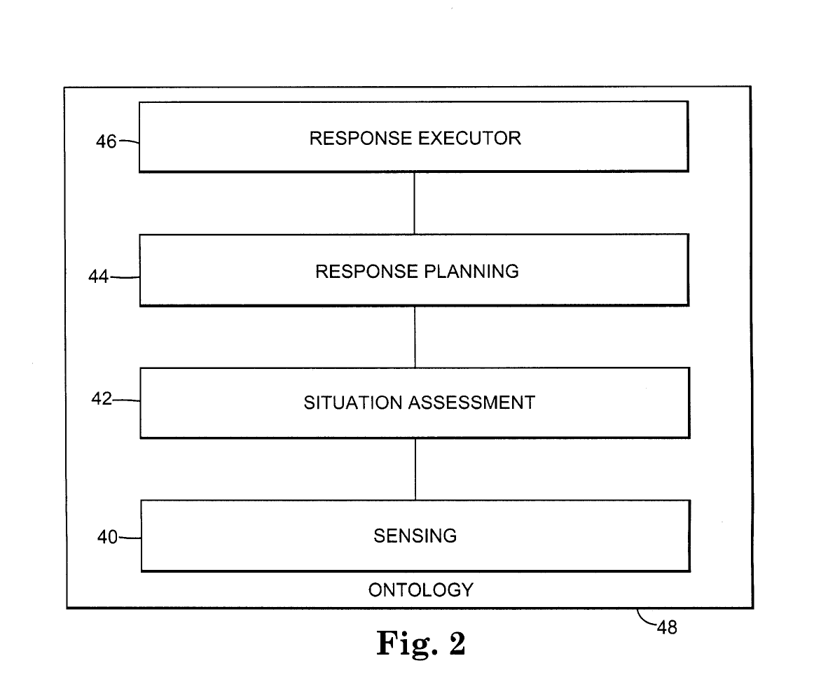

With the above in mind, and with reference to FIG. 2, the preferred system architecture entails four main categories of capability that can be described as fitting into a layered hierarchy. These include sensing 40, situation assessment 42, response planning 44, and response execution 46. In general terms, the sensing layer 40 coordinates signaled information from multiple sensor sources, preferably clustering multiple sensor reports into a single event. With respect to the situation assessment layer 42, based upon information provided via the sensing layer 40, an attempt is made to understand the current situation of the actor 28, whether it is describing the person or persons in the environment being monitored (e.g., the actor 28, caregivers, pets, postal workers, etc.), or physical properties of the environment (e.g., stove on/off, door opened/closed, vase fell in the kitchen, etc.). The situation assessment layer 42 will preferably include a number of components or sub-layers, such as intent recognition for understanding what actors are trying to do, and response monitoring for adaptation. Regardless, based upon the situation assessment information provided by the situation assessment layer 42, the response planning layer 44 generates an appropriate response plan, such as what to do or whom to talk to, how to present the devised response, and on what particular effector(s) 26 (FIG. 1) the response should be effected. Finally, the response execution layer 46 effectuates the response plan generated by the response planning layer 44. Each of these functions are described in greater detail below.

Within each of the layers 40-46 or across two or more of the layers 40-46, one or more computational components can be employed. In a preferred embodiment, the architecture associated with the system 20 has components that are agent-oriented such that the system 20 provides multiple independent computational threads, and encourages a task-centered model of computation. By encouraging a task-centered model of computation, the system 20 benefits from the natural byproduct of decoupled areas of computational responsibility. The multi-threaded computational model enhances this decoupling by supporting a system that makes use of the different levels of granularity that a problem presents. In one embodiment, the agents can migrate from one computational platform (or layer) to another to balance loads. Thus, the preferred system 20 provides an agent or agents responsible for various capabilities essential to good system performance available at several levels of computational responsibility, from device control to user task tracking.

The model of the preferred system 20 is expressed in an ontology and agent communication protocol (referenced generally at 48 in FIG. 2) that forms a common language to describe the domain. This ontologically mediated inter-agent communication provides an additional benefit; it gives components the ability to discover services provided by other agents, often through the services of a matchmaker. Discovery directly provides the opportunity for an independent agent to expand its range of knowledge without radically changing its control focus. As a result, discovery allows the overall system 20 to grow at run-time without adversely affecting functionality. Thus, the preferred agent-oriented approach provides modularity, independence, distribution, discovery, and social convention.

The preferred agent architecture associated with the system 20 is defined as a federated set of agents that define agent interfaces. In this regard, as used throughout the specification, a “system agent” or “agents” is defined as a software module that is designed around fulfilling a single task or goal, and provides at least one agent interface. An individual system agent is intended to perform a single (possibly very high level) task. Examples of the agent's task include interaction with a user or caregiver, preventing fires in a kitchen, interfacing with a medication-monitoring device, monitor long term trends, learning, filtering sensor noise, device management (e.g., speech or video understanding, television operation, etc.), etc. The system agent is the basic delivery and compositional unit of the system 20 architecture. As such, different software venders can provide agents for installation in the system 20 to provide new functionality. While the system 20 will preferably have, at its core, a small set of agents that will be present in every installation of the system 20, the breakdown of system functionality into agents is designed to allow a flexible modularity to the system 20 construction. Choosing agents on the basis of provided functionality will allow the actor 28 (or a person responsible for his/her care) to customize the system 20 to provide only those functions they want to have without requiring the adoption of functionality that they are not interested in. Although the preferred system 20 architecture has been described as being agent-based, other configurations capable of performing the situation assessment, response planning, and response plan implementation features described below are also acceptable.

Agent interfaces provide the inter-agent communication and interaction for the system 20. Each agent must make available at least one agent interface. In contrast to the task-organized functionality provided by agents, the agent interfaces are designed to allow the agents to provide functionality to each other. They provide for and foster specific kinds of interactions between the agents by restricting the kinds of information that can be provided through each interface.

In a preferred embodiment, the system 20 provides three types of agent interfaces, including a “Sensor agent interface”, and “Actuator agent interface”, and a “Reasoner agent interface” (hereinafter referred to as “SRA interfaces”). A sensor agent interface answers questions about the current state of the world, such as “is the stove on/off?”, “has the user taken his/her medication for the day?”, “is the user in the house?”, etc. These interfaces allow others to interact with the agent as though it is just a sensor. An example of this kind of interface is a kitchen fire safety agent that allows other agents to know the state of the stove. An actuator agent interface accepts requests for actions to change/modify the world, for example, including: turning the stove on/off, calling the user on the phone, flashing the lights, etc. These interfaces allow the agent to be used by others as a simple actuator. Preferably, the monitoring of an action to verify that it has been done would be carried out by the agent implementing the actuator agent interface rather than by the agent requesting the action. Finally, a reasoner agent interface answers questions about the future state of the world such as, for example, “will the user be home tonight?” or “can the user turn off the television?”, etc. These interfaces are designed to allow the agent to perform reasoning for other agents.

In general, each agent will preferably have more than one interface and may even provide multiple interfaces of the same type. For example, a kitchen fire safety agent can provide a sensor agent interface for the state of the stove and a similar, but separate, agent interface for the toaster oven. Similarly, the kitchen fire safety agent preferably provides a sensor interface for indicating a current state of the stove, an actuator interface that allows changing of a stove temperature or activation/deactivation, and a reasoner agent interface that determines an expected future state of the stove. In a preferred embodiment, when an agent is registered as part of the system 20, it will register the agent interfaces that it makes available. Other agents that wish to make use of these interfaces can be informed of the availability and be reconfigured accordingly. This preferred agent discovery process entails discovery of software features and capabilities of available agents, and is not otherwise available with existing protocols, such as Universal Plug and Play (“UPnP”)

One of the benefits associated with the preferred agent-oriented paradigm is reflection. Reflection is the process of reasoning about and acting upon one's self. Reflection is present at both the individual and social levels of properly constructed agent systems. Reflection at the single agent level primarily means that the agent can reason about the importance of its goals and commitments in a dynamic environment; it is apparent in explicit models of goals, tasks, and execution state. An agent's ability to reason about goals and commitments in the context of an agent system is provided by a common, interchangeable task model.

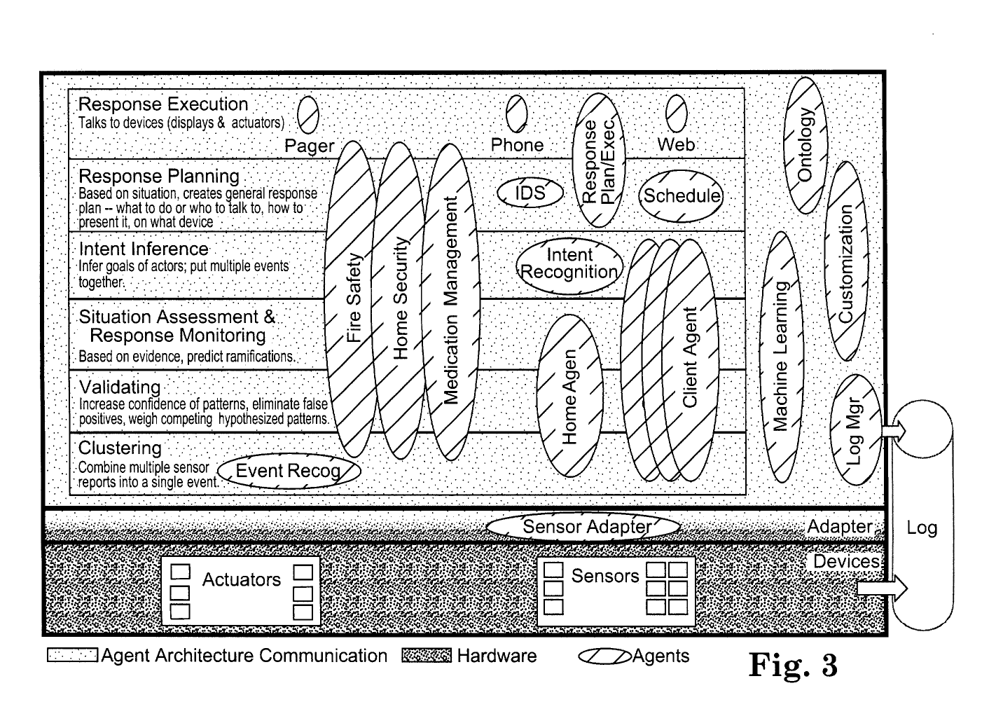

One preferred embodiment of the system 20 architectural organization, including preferred layer-agent interrelationships, is provided in FIG. 3. The framework illustrated in FIG. 3 includes multiple layers that correspond to the situation assessment layer 42 of FIG. 2, including “clustering”, “validating”, “situation assessment and response monitoring”, and “intent inference”. Further, FIG. 3 illustrates various agents within each layer and/or acting within several layers. In this regard, exemplary domain agents are provided (including “fire safety”, “home security”, and “medication management”). It will be understood that these are but a few examples of domain agents that can be used with the system 20 of the present invention.

The various layers identified in FIG. 3 provide a framework in which to describe an agent's capability, rather than a strict enforcement of code. Further, there are some agents that reside outside of this framework, notably because they are not part of the “reasoning chain” in quite the same way. These would include, for example, customization and configuration (that interacts with an actor to gather system set-up information), “machine learning” (described in greater detail below; generally refers to building models of the particular application environment and normal activities of the actor 28 that are used by caregivers of the system 20 to intervene or improve system accuracy and responsiveness), and a log manager (to mediate access to system databases). Further, devices (both sensors and actuators) reside in the device layer, communicating with a standard device communication protocol. The agents communicate within an agent infrastructure. In one preferred embodiment, one or more agents are provided that function as adaptors to translate device messages.

The agents associated with FIG. 3 are depicted as larger ovals according to functional groupings. In a preferred embodiment, each of the agents shown in FIG. 3 provides all of the functionality related to the particular subject matter. For example, the domain agents described above can further include an “eating” agent that provides all of the functionality related to the actor's 28 eating habits, including, for example, monitoring what and when the user is eating, monitoring the freshness of food, creating menus and grocery lists, and raising alerts when necessary.

Communication between the agents of FIG. 3 is preferably performed through one or more of the three SRA interfaces previously described. Within an agent, agent-components may communicate using whatever mechanism they choose, including the extremes of: (1) choosing to be one piece of undifferentiated code that requires no communication, or (2) using their own proprietary communication method, or (3) choosing to use the preferred system ontology in a communication protocol.

While it is unlikely that an agent or agent-component residing in the response planning layer will want to or need access to an agent in the pattern matching layer (i.e., skipping layers), the preferred architecture will not restrict this information flow. In short, response planner layer agents need only maintain “ontological purity” in their communications with other agents. This same preferred feature holds true for agents that can reason over multiple layers in the reasoning architecture. “Ontological purity” means that the ontology defines concepts that can be shared or inspected between agents, and those concepts exist within a level of the reasoning architecture. Concepts can be used within or across levels or layers, but preferably must be maintained across agents.

The particular infrastructure framework utilized for the system agent system architecture can assume a variety of forms, including FIPA-OS, AgentTool, Zeus, MadKit, OAA2, JAFMAS, JADE, DECAF, etc.

C. Preferred Agent Features

Several of the layers and/or agents illustrated in the layered architecture of FIG. 3 preferably provide added “intelligence” to the system 20, and are described in greater detail below. It should be noted, however, that regardless of whether one or more of the features are included, the overall layered architecture configuration of the system 20 provides a heretofore unavailable platform for seamlessly associating each of these features in a manner that preferably facilitates complete monitoring, recognizing, supporting and responding to the behavior of an actor in every day life, it being understood that the present invention is not limited to facilitating all of these functions (e.g., supporting and responding to behavior are not mandatory features).

For example, devices in the various layers preferably can directly write to the log. Agents preferably go through the log manager that selectively returns only the requested information. Alternatively, the system 20 architecture can be adapted such that non-agents can access and review information stored within the log manager (e.g., a doctor's office would represent a non-agent that could benefit by having access to the log manager). Along these same lines, the system 20 can be adapted such that non-agents are able to write data into the log manager, but on a mediated basis.

The “sensor adapter” agent is preferably adapted to read the log of sensor firings, compensate for any latencies in data transmission, and then forward the information into the agent architecture.

The “clustering” layer is provided to combine multiple sensory streams into a single event. For example, for a particular system 20 installation, the sensors can include a pressure-mat sensor in the kitchen, a pressure-mat sensor in the hall, and a motion sensor in the kitchen. The preferred “event” agent associated with the clustering layer can interpret a three-sensor sequence of these sensors as probably reporting on the same event, namely entering the kitchen. The “situation assessment and response monitoring” layer aggregates evidence presented by the various sensors and agents to predict a most likely ramification of the current user situation. In this regard, the layering preferably includes monitoring the effects of a subsequently-implemented response plan. For example, a particular situation assessment may conclude that the actor 28 has fallen. The resulting response plan is to ask the actor 28 whether or not he/she is “okay”. If, under these circumstances, the actor 28 does not respond to the question, then the response monitoring layer can conclude that the detected fall is likely to be more serious.

The “client” agent and the “home” agent monitor and manage information relating to the actor and the actor's environment, respectively. The client agent information preferably includes current and past information, such as location, activity and capabilities, as well as preferred interaction mechanisms. The information can be predetermined (provided directly by the actor and/or caregiver), inferred (via situation assessment or intent recognition), and/or learned (machine learning). Where the particular environment includes multiple actors (e.g., a spouse), a separate client agent will preferably be provided for each actor. The home agent information preferably includes environment lay-out, sensor configurations, and normal sensor patterns. Again, the information may be predetermined, inferred and/or learned.

A further preferred feature of the previously-described “domain” agents is a responsibility for all reasoning related to its functional area. Each domain agent performs situation assessment, provides intent recognition libraries (described below), and creates initial response plans. With respect to the proposed response plan, each domain agent is preferably adapted to decide whether, for a particular situation, to wait for additional information, explicitly gather more information, or interact with the actor and/or caregiver. The domain agent further needs to decide what actor interaction/interface device(s) to preferably use, what modality to preferably use on selected devices, and, where appropriate, which person(s) to preferably contact in the event that outside assistance is determined necessary. The domain agent preferably proposes an interaction based only on its specialized knowledge; in other words it proposes a “context-free” response.

The “intent inference” layer preferably includes an “intent recognition” agent that, in conjunction with intent recognition libraries, pools multiple sensed events and infers goals of the actor, or more simply, formulates “what is the actor trying to do”. For example, going into the kitchen, opening the refrigerator, and turning on the stove likely indicate that the actor is preparing a meal. Alternative intent inference evaluations include inferring that the actor is leaving the house, going to bed, etc. In general terms, the preferred intent recognition agent (or intent inference layer) entails repeatedly generating a set of possible intended goals (or activities) by the actor for a particular observed event or action, with each “new” set of possible intended goals being based upon an extension of the observed sequence of actions with hypothesized unobserved actions consistent with the observed actions. The library of plans that describe the behavior of the actor (upon which the intent recognition is based) are provided by the “domain” agents. In a preferred embodiment, the system 20 probabilistically infers intended goals pursuant to a methodology in which potentially abandoned goals are eliminated from consideration, as taught, for example, in U.S. Provisional Application Serial No. 60/351,300, filed Jan. 22, 2002, the teachings of which are incorporated herein by reference. The preferred intent inference layer improves the response planning capabilities of the system 20 because the response planner is able to “preemptively” respond. For example, with intent inference capabilities, the system 20 architecture can lock a door before a demented actor attempts to leave his/her home, provide next step-type suggestions to an actor experiencing difficulties with a particular activity or task, suppress certain warning alarms in response to a minor kitchen fire upon recognizing that the actor is quickly moving toward the kitchen, etc.

The preferred architecture of FIG. 3 further includes an “IDS” agent. This is in reference to an Interaction Design System agent that processes sensor data to understand a particular situation, needs and capabilities of the actor 28 and available effectors that, as part of the Response Planning layer, are used to develop interaction plans. That is to say, the IDS agent provides information for developing a series of control actions designed to assist the actor through information presentation or adaptive automation behaviors. Thus, the preferred IDS agent reasons about which user interaction/interface device to utilize for informing the actor of a particular plan. The adaptive interaction generation feature promotes planned responses adapting, over time, to how the actor 28 (or others) responds to particular plan strategies. By further accounting for the urgency of a particular message, the preferred IDS agent dynamically responds to the current situation, and allows more flexible accommodation of the interaction/interface devices.

An additional feature preferably incorporated into the Situation Assessment and Response Monitoring layer is an inactivity monitoring feature. The inactivity monitoring feature is preferably provided as part of the “machine learning” agent (described below) or as part of individual domain agents, and relates to an expected actor activity (e.g., the actor should wake up at 8 a.m., the actor should reach the bottom of the stairs within one minute of starting to descend) that does not occur. In other words, the preferred system 20 architecture not only accounts for unexpected activities or events, but also for the failure of an expected activity to occur, with this failure being cause for alarm. The inactivity monitoring function is primarily model based, and can include accumulated information such as a history of the actor's activities; a profile of the actor's environment; hardware-based sensor readings; information about the current state of the world (e.g., time of day); information about the caregiver's activities (where applicable); a prediction of the future actions of the actor and/or caregiver; predictions about the future state of the world; predetermined actor, caregiver and/or environment profiles; and predetermined actor and/or caregiver models, settings, or preferences. The inactivity monitoring mechanism preferably can detect the unexpected inactivities that would otherwise go unnoticed by an activity only-based concept of monitoring. It does so by comparing the actor's current activities with his/her preset and/or expected patterns. In a preferred embodiment, certain thresholds are implemented to allow for flexibility in the actor's schedule. However, there are certain recognizable patterns within the day, and within each activity. For example, if the actor is expected rise from bed between 8 a.m. and 10 a.m., and no activity has been detected during this time, the system 20 can be adapted to raise an alarm notifying a designated caregiver(s). By way of further example, and at a different granularity, if the actor 28 is descending from the stairs, and no motion is detected at the bottom of the staircase after a predetermined length of time, the system 20 can be adapted to raise an alarm. Therefore, the established threshold of the inactivity monitoring mechanism enables the system 20 to detect a greater range of unexpected behaviors and possibly dangerous situations.

In conjunction with the above-described inactivity monitoring feature, the preferred system 20 architecture further includes an Unexpected Activity/Inactivity Response feature in the form of a module or agent that determines if the actor 28 needs assistance by monitoring for signs of unusual activity or inactivity. Given the “normal” or expected behavior of the actor 28 or the actor's environment, unusual activity can trigger a response. For example, movement in the basement when the actor 28 is normally asleep could trigger an intruder alarm response. This augments the above-described inactivity monitoring feature by adding a learned or programmed model of the normal/usual activities, and includes, in addition to the above listed information, learned actor, caregiver and/or environmental usual patterns; learned actor, caregiver, and/or environmental profiles; and learned actor and/or caregiver preferences.

The “response plan/exec” agent preferably includes a response coordination feature that coordinates the responses of the “domain” agents. The response coordinator preferably merges or suppresses interactions or changes interaction modality, as appropriate, based upon context. For example, if the actor 28 has fallen (entailing an “alarm” response), the response coordinator can suppress a reminder to take medication. Multiple reminders to the actor 28 can be merged into one message. Multiple alert requests to different devices can be merged onto one device. To this end, merged messages will preferably be sorted by priority, where priority is defined by the domain agent, as well as by the type of message (e.g., an alarm is more important than an alert). Preferably, the response plan/exec agent centralizes agent coordination, but alternatively the system 20 architecture can employ distributed modes. The preferred centralized response coordination approach, however, is feasible because all of the involved agents interact with a small sub-set of users through a small sub-set of devices. In other words, all activities involving communications with the outside world are strongly interrelated. Thus, while the agents are loosely coupled, their responses are not.

The “machine learning” agent provides a means for ongoing adaptation and improvement of system 20 responsiveness relative to the needs of the actor 28. The machine learning agent preferably entails a behavior model built over time for the actor 28 and/or the actor's environment. In general terms, the model is built by accumulating passive (or sensor-supplied) data and/or active (actor and/or caregiver entered) data in an appropriate database. The data can be simply stored “as is”, or an evaluation(s) of the data can be performed for deriving event(s) and/or properties of event(s) as described, for example, in U.S. Provisional Patent Application Serial No. 60/834,899, filed May 30, 2002, the teachings are incorporated herein by reference. Regardless, other modules in the system 20 preferably can utilize the learned models to adapt or change their operation. For example, the Response Planning layer will likely consider alternative plans or actions. Learning the previous success or failure of a chosen plan or action enables continuous improvement. In the realm of actor interaction and where the machine learning agent (or similar module) is provided, the system 20 can learn, for example, the most effective modality for a message; the most effective volume, repetition, or duration within a modality; and the actor's preferences regarding modality, intensity, etc. Thus, the mechanism for learning can account for contextual conditions (e.g., audio messages are ineffective when the actor is in the kitchen).

Finally, the “customization” (or “configuration”) agent is preferably adapted to allow an installer of the system 20 to input configuration information about the actor, the caregiver (where relevant), other persons acting in the environment, as well as relevant information about the environment itself.

D. Preferred Architecture Functioning

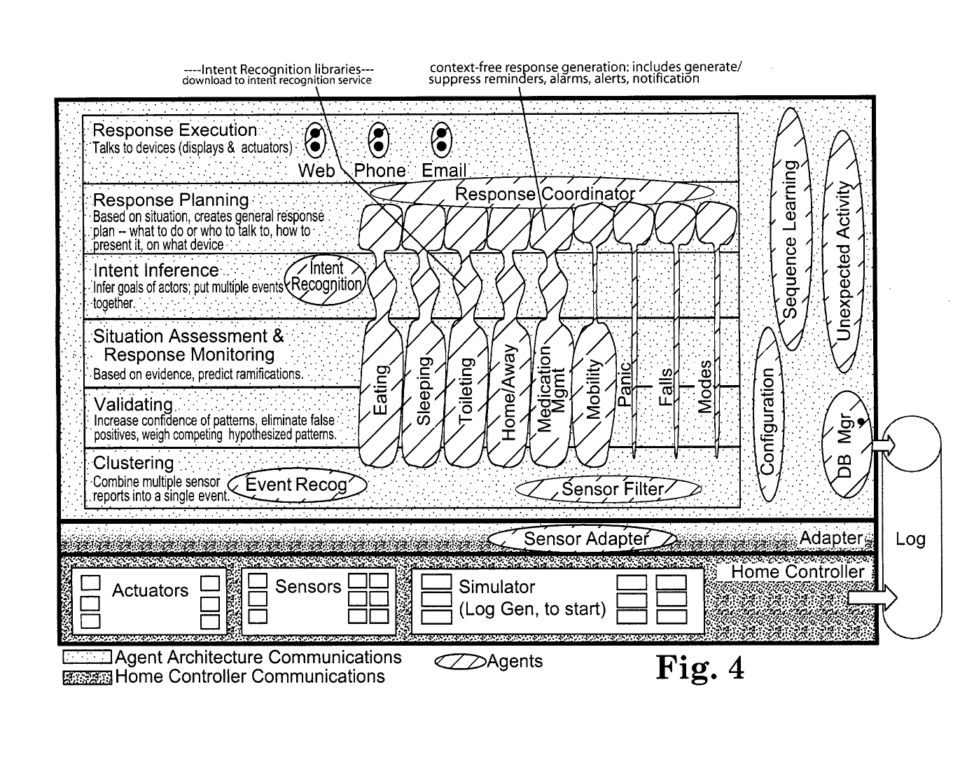

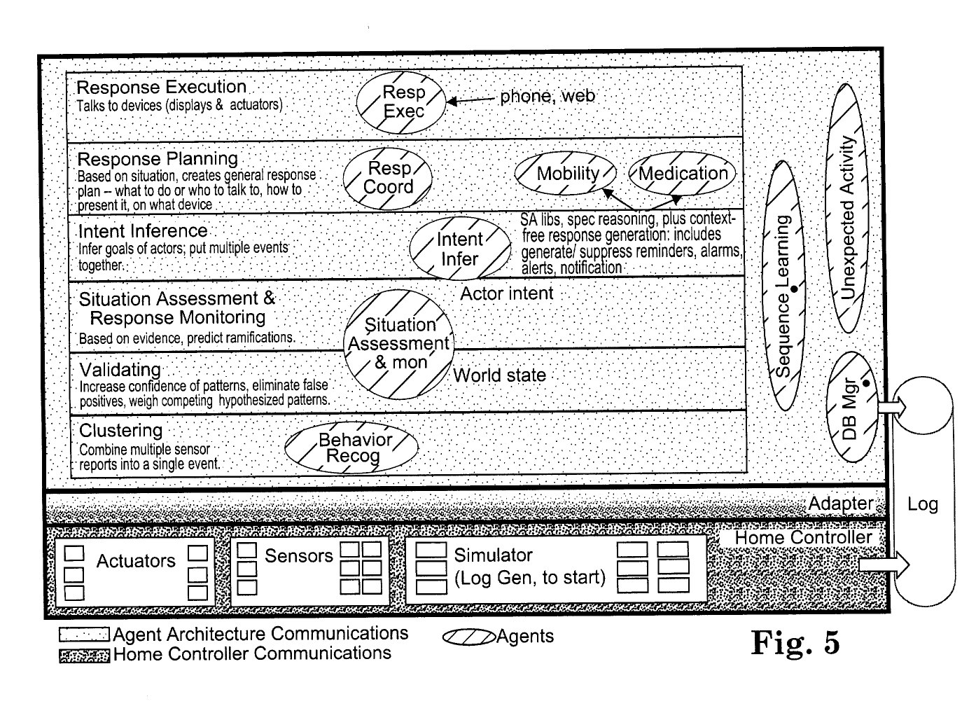

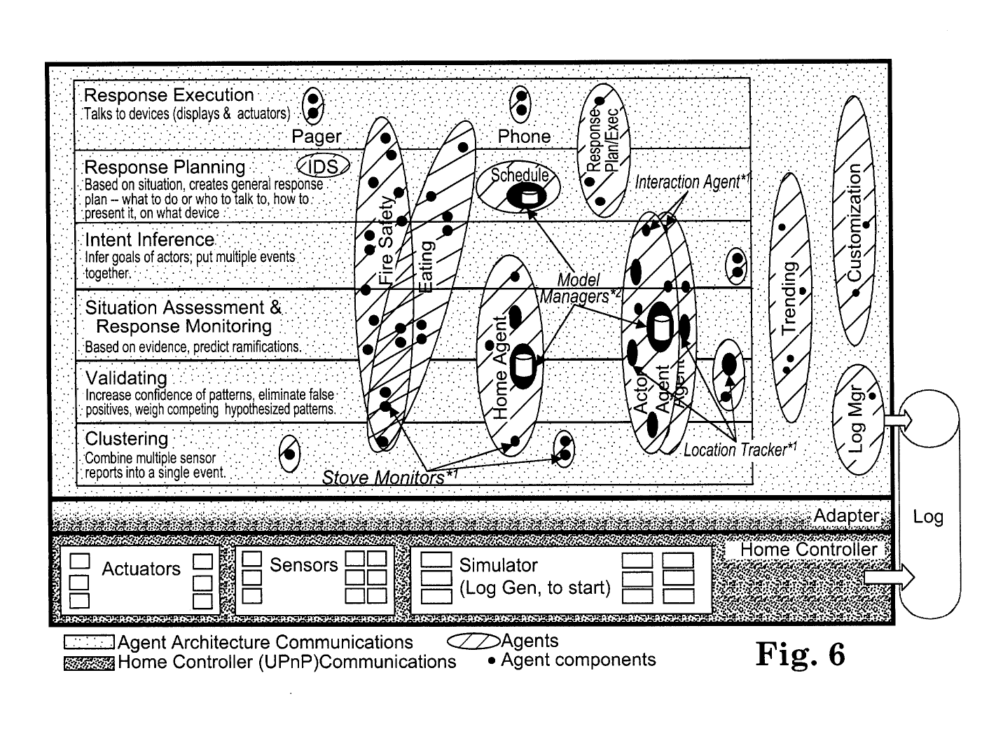

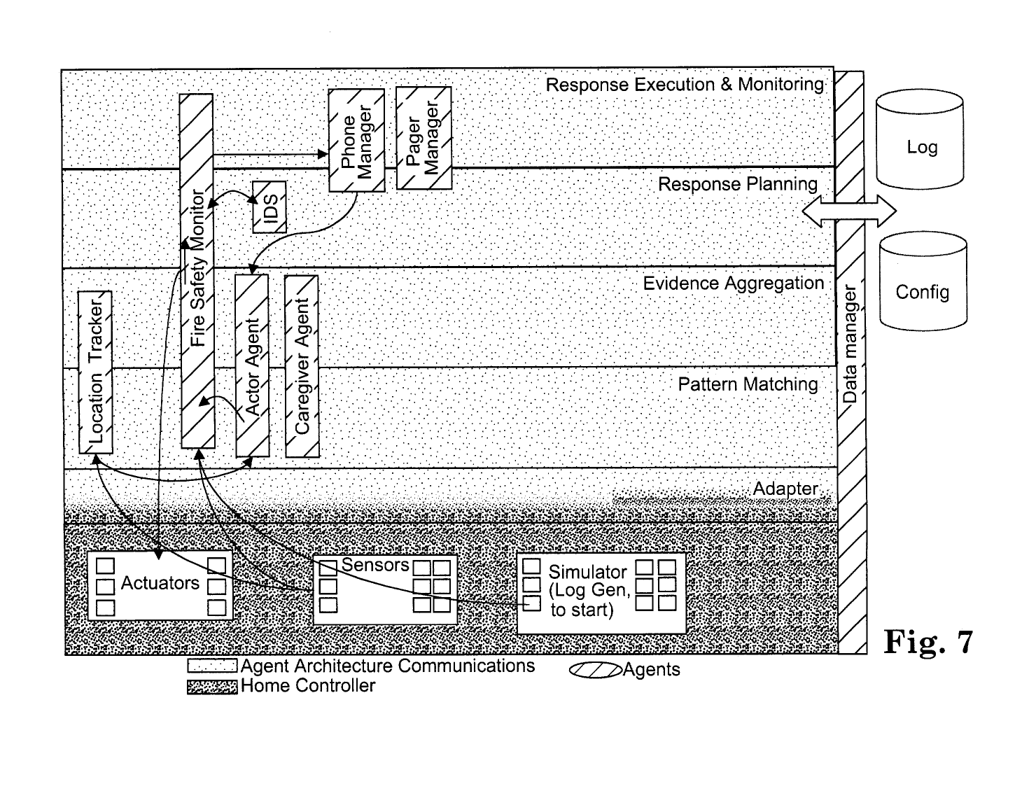

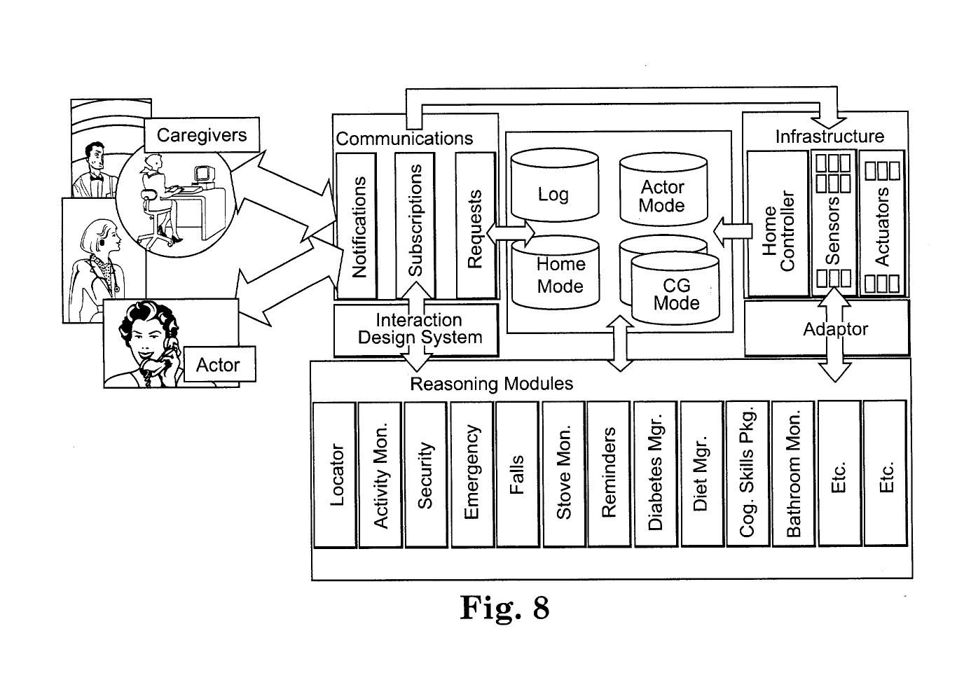

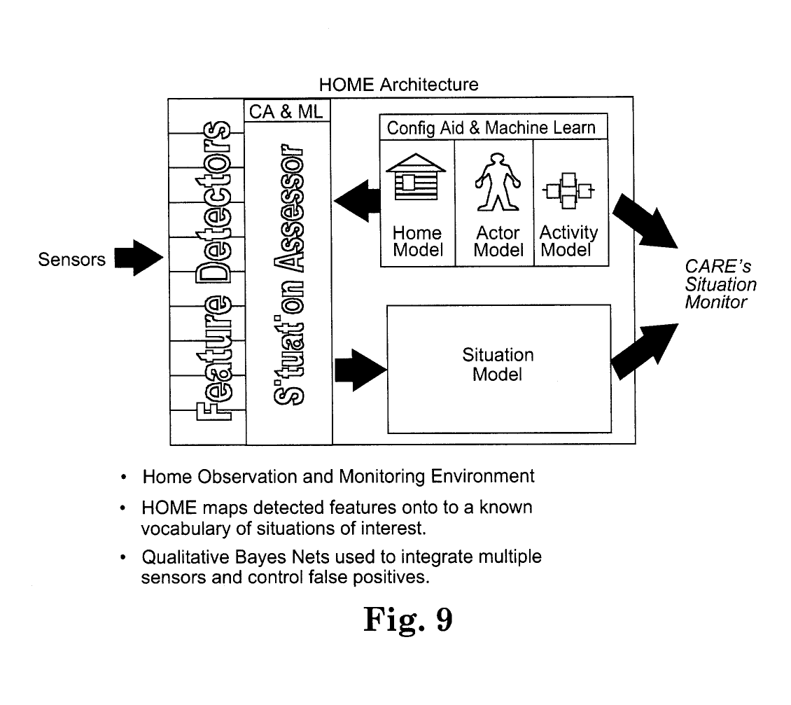

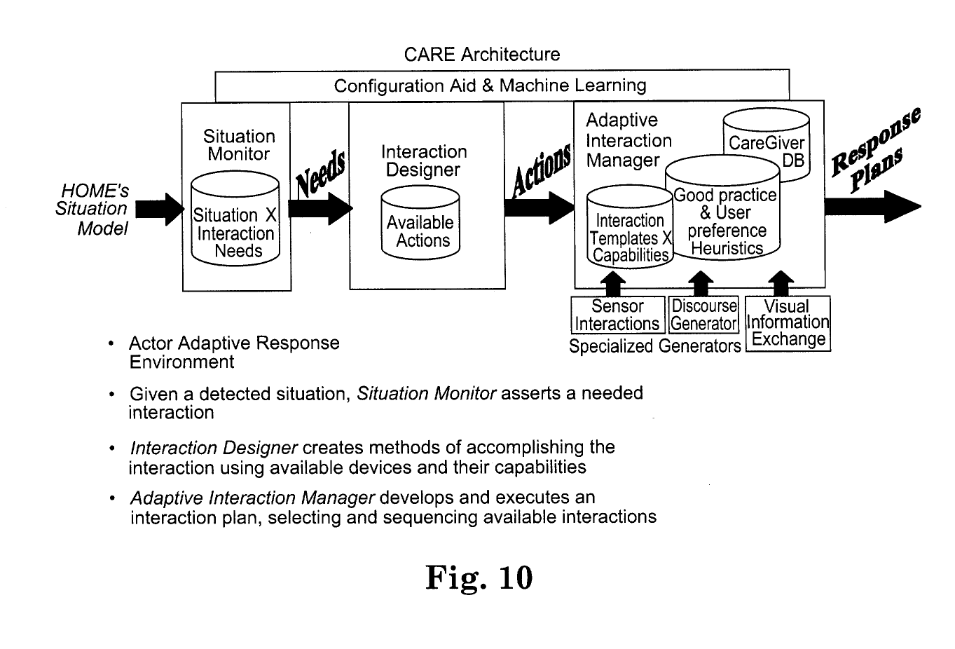

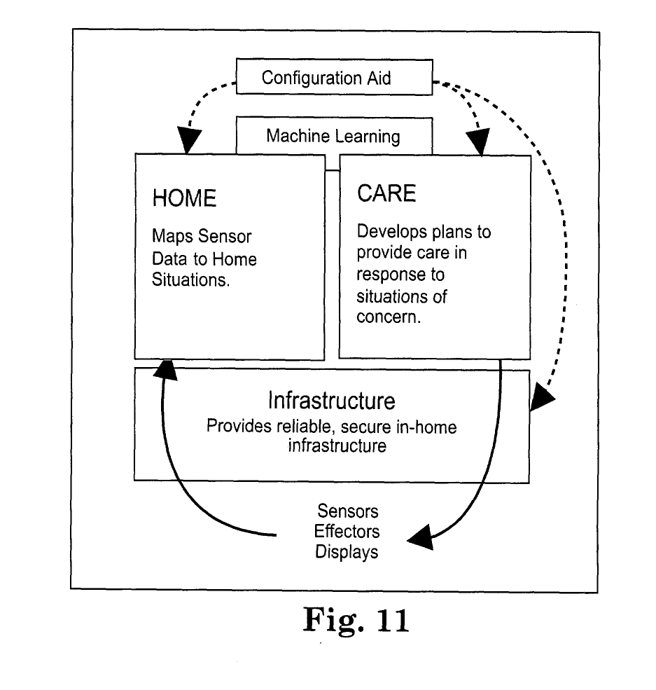

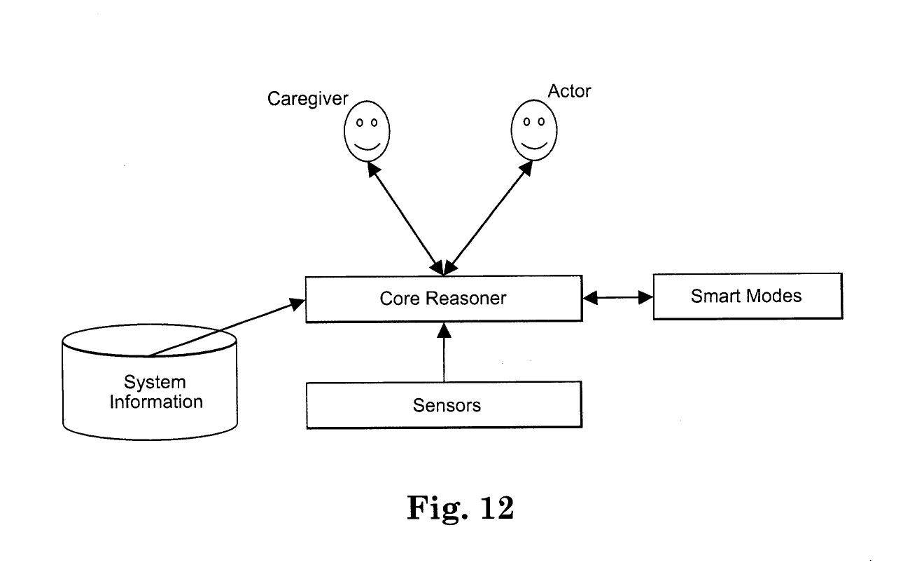

The layered architecture presented in FIG. 3 is but one example of an appropriate configuration useful with the system 20 of the present invention. Other exemplary architectures are presented in FIGS. 4-11. For example, the exemplary architecture of FIG. 5 incorporates a more “horizontal” cut of agent functionality whereby there is generally one agent per layer that performs all the tasks required for that layer. By way of comparison, all situation assessment is carried out by a single agent within the architecture of FIG. 5, whereas individual agents are provided for selected situations with the architecture of FIG. 3 (e.g., all medication management-related assessment occurs in the medication management agent). As a point of clarification, several of FIGS. 4-11 include the term “CARE” which is in reference to “client adaptive response environment” and the term “HOME” is in reference to “home observation and monitoring environment”, both of which represent system components in accordance with the present invention.

Regardless of the exact architectural configuration, a preferred feature of the system 20 is an ability to mediate and resolve multiple actuation requests. In particular, the system 20 is preferably adapted to handle multiple conflicting requests made to an agent interface. In one preferred embodiment, this functionality is performed at the level of individual actuator agent interfaces. Alternatively, a central planning committee design can be instituted. However, the central planning committee technique would require a blackboard-type architecture, and would require providing all information needed to make a global decision rather than a local one. Given these restrictions, it is preferred that each actuator agent interface be required to handle the multiple conflicting request issue on an individual basis.

A first problem associated with multiple conflicting requests relates to multiple priority messages. In a preferred embodiment, each actuation request is provided with a priority “level” (e.g., on the scale of 1-5). Each priority level represents an order of magnitude jump from the level below it. The effect of this is that all requests of the same priority level are of the same importance and can be shuffled or reordered. Requests of a high level preempt all lower priority requests. Preferably, this priority scheme does not include an “urgency” factor for the requests. With this model, the requesting agent places a request for the specified action at a particular time with a given priority. If the actuator agent is unable to fulfill that request, the requesting agent is so-notified. The requesting agent is then free to raise the priority of the request or to consider other methods of achieving the goal. Thus, reasoning about the urgency of the action is left within the requesting agent, and all arbitration at the actuator level is performed on the basis of the priority of the request.

An additional multiple request-related concern is one request interfering with the processing of (or “clobbering”) another request. One of the traditional methods for handling this kind of problem is to allow the agents to pass portions of plans between themselves in order to explain the rationale for the action and to reach an agreement about the actions that need to be executed. This provides the information needed for the agents to resolve any conflicts between the actions of each of their plans. In a preferred embodiment, however, a limited form of this partial plan solution is provided. In addition to a specific request from an agent, the requesting agent must specify the environment that the request should be fulfilled in. In artificial intelligence terminology, the conditions embodied by causal links between plan steps must be provided to the executing agent. The preferred system 20 does this by specifying a list of sensor agent interface queries and their return values. In effect, this provides a list of predicates that must be true before the action is performed. If the specified conditions do not hold, then the system 20 cannot honor the request and will report that fact. Note that if an agent wants to ensure that some predicate, not provided by a sensor agent interface, holds during the execution of an action request, then it can provide the sensor agent interface necessary for the action. It should further be noted that in general, the “clobbering” concern is more relevant for actuator requests than reasoner or sensor agents, but these requirements are preferably placed in all three classes of agent interfaces.

The sensor integration, situation assessment and response planning features of the system 20 architecture present distinct advancements over previous in-home monitoring systems, and allows the system 20 to provide automated monitoring, supporting and responding to the activities (or inactivities) of the actor 28. This infrastructure provides a basis for building automated learning techniques that could generate actor-specific information (e.g., medical conditions, schedules, sensor noise, actor interests) that in turn can be used to generate better responses (e.g., notify doctors, better reminders, reduce false alarms, suggest activities). The situation assessment can be performed at a variety of levels of abstraction. For example, the system 20 can confer or assess a situation based upon stimulus-response, whereby a sensor directs an immediate response (e.g., modern security systems, motion-sensor path-lighting, or a heart rate monitor that raises an alarm if the heart rate drops precipitously). Preferably, the system 20 can “notice” and automatically control events before they actually occur, as opposed to the existing technique of simply responding to an event. This is preferably accomplished by providing the situation assessment layer with the ability to predict events based upon the potential ramifications of an existing situation, and then respond to this prediction. For example, the situation assessment layer is preferably adapted to notice that the stove is about to catch fire, and then act to turn the stove off; or turn the water heater off before the actor gets burned; etc. In addition to the above and in a preferred embodiment, the system 20 architecture is highly proactive in automatically responding to “events” (beyond responding to “alarm” situations); for example automatically arming a security system upon determining that the actor has gone to bed, automatically locking the actor's home door upon determining that the actor has left the home; etc.

Preferably, explicit reasoning modules for specific behaviors are incorporated into the system 20 architecture (e.g., a tracking algorithm that calculates the user's path based on motion-sensor events), and then possibly projects future states (e.g., turning on lights where the client is going, or locking the front door before the user wanders outside, or a video algorithm that recognizes faces). These modules may be a “library” of behavior recognition techniques, such as a set of functions that are explicitly designed to recognize one (or a small number) behavior. Alternatively, the system 20 architecture can be adapted such that individual agents build customized techniques for recognizing/obtaining information subtleties that are not required by other agents (e.g., a general vision agent could be configured to recognize food going into the actor's 28 mouth; a medications agent would want to know whether an ingested pill was of a certain color and nothing more, thereby allowing the medication agent to more efficiently and effectively interact with vision agent and implement the vision technique internally to the medication agent). Further, a “central” algorithm that weighs all likely current situations can be provided.

Additionally, the system 20 preferably performs condition-based monitoring that uses data from hardware-based sensors in conjunction with other information from various sources. The goals of condition-based monitoring are to provide greater accuracy for the assessment of the actor's current condition, include details with alarms raised, filter out unnecessary or inappropriate alarms, and also reduce the number of false alarms. The information that could potentially be used to perform condition-based monitoring includes: a history of the actor's activities; a profile of the actor's 28 environment; hardware-based sensor readings; information about the current state of the world, including for example, the actor's location, the time of day, the day of week, planned activity calendar, and the number of people in the environment; information about the caregiver's activities; a prediction of the future actions of the actor or caregiver; a prediction of the future state of the world; user/caregiver/environmental patterns or profiles, actor/caregiver preferences; etc.

By including additional information about the actor's environment, the system 20 can evaluate the current situation with more accuracy. Based upon the current condition of the environment and the recent history of actor 28 activities, the system 20 can initiate alarms and alerts in an appropriate manner, and assign an appropriate level of urgency. For example, the system 20 may reason that a possible fall sensor event (e.g., from a hardware-based sensor) that follows a shower event (e.g., from the history of the actor's activities) has a higher probability of the actor 28 suffering an injury-causing fall than a possible fall event that occurred on a dry, level surface (e.g., from the environment model). The system 20 can also reason that a toileting reminder may be inappropriate when there are guests in the actor's environment. Such monitoring mechanisms can be used by an automated response planner to decide how to respond-including for example, whether to actuate a device in the house (e.g., to turn on the lights), to raise an alarm/alert, to send a report, or to do nothing. The information can also be included with each alarm to better aid the caregiver in assessing the actor's well-being. Further, the preferred system 20 architecture preferably promotes sharing of inferred states (via the intent inference layer) across multiple sensors and performing second-order sensor processing. For example, a motion sensor may indicate movement in a particular room, whereas a GPS transponder carried on the actor's 28 person indicates that he/she is away from home. With this information, the situation assessment layer preferably reasons that either a window has been left open or there is an intruder. Based upon this second-order analysis, the system 20 architecture polls the relevant window sensor to determine whether the window is open or closed before initiating a final response plan.

The preferred agent layering architecture of the present invention facilitates not only allowing third parties to incorporate new devices into the system 20 at any time, but also to allow third parties to incorporate new reasoning modules at any time into the system 20. In this regard, third party reasoning modules can use new or existing devices as sensing or actuating mechanisms, and may provide information or user information from other reasoning modules. To ensure that new devices and control services can coherently interact with existing devices in the particular system installation, a consolidated home ontology is provided that includes the terms of the language that devices and control services must use to communicate with one another. Thus, newly added devices or agents can find other agents within the system 20 architecture that otherwise supply information that the new device or agent is interested in.

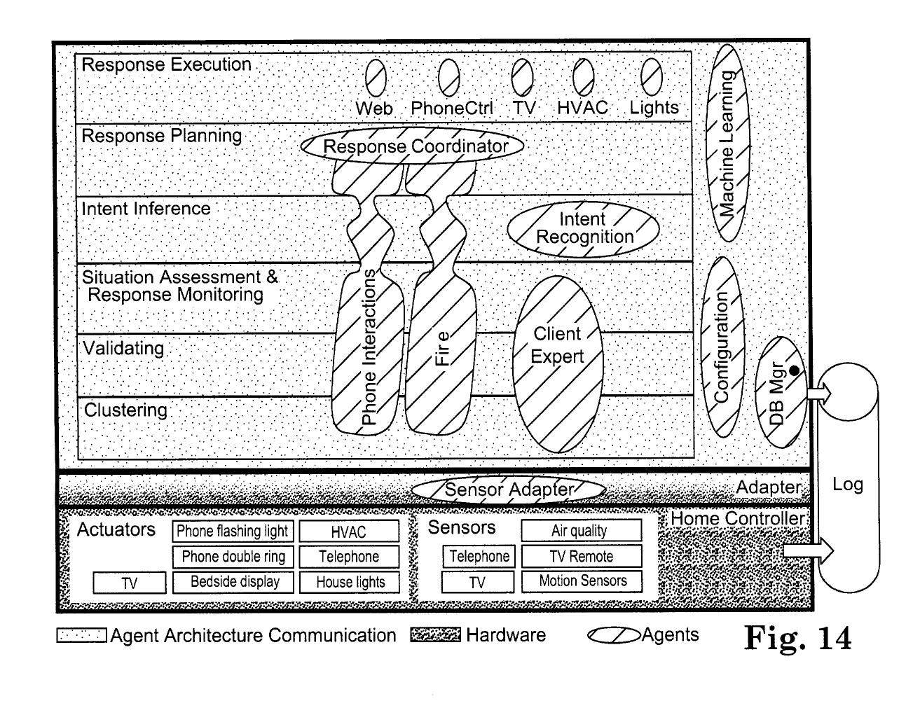

As previously described, the response planning and response execution layers associated with the system 20 architecture can assume a variety of forms, some of which initiate further passive monitoring, and others that entail active interaction with the actor. In addition, the system 20 preferably incorporates smart modes or agents into the response planning layer. In general terms, the smart modes entail querying the actor as to his/her status (mental/physical/emotional), the response to which is then combined with other sensor data to make inferences and re-adjust the system behavior. Some exemplary modes include “guest present”, “vacation”, “feeling sick”, and “wants quiet” (or mute). For example, the actor 28 may indicate that she is not feeling well when she wakes up. The system 20 can then ask the actor 28 to indicate a few of her symptoms and can give the actor 28 an opportunity to specify needs (e.g., need to get some juice and chicken soup; need to make a doctor appointment; need to call caregiver; do nothing; etc.). The system 20 then uses this information to adjust its reasoning, activities, and notifications accordingly. Continuing the previous example, if the actor 28 later skips taking medications, any notifications preferably include information about the actor 28 feeling ill. If the system 20 has access to an appropriate database, it can match the actor's symptoms against the database given that it knows that the actor 28 has, for example, started a new prescription the day before (and issues alerts based upon the match if required). Further, the system 20 preferably can reduce general activity reminders; cancel appointments; reduce notification thresholds for general activities like mobility, toileting, eating; increased reminders to drink fluids; add facial tissues and cold medicine to the shopping list ; etc. Along these same lines, it is noted that the preferred system 20 reasons through multiple layers of refinement within the system. The smart mode states will act as individual pieces of information in the reasoning steps that aggregate evidence from a specific situation, a world understanding, and the smart modes themselves. This acts as a dynamic system, supporting reasoning based on an actual situation rather than a predefined sequence. FIG. 14 provides a block diagram of one example of the system 20 incorporating smart mode information. The smart mode can be an agent within the system 20 architecture, or could be within each of the domain agents.

E. Exemplary Method of Operation

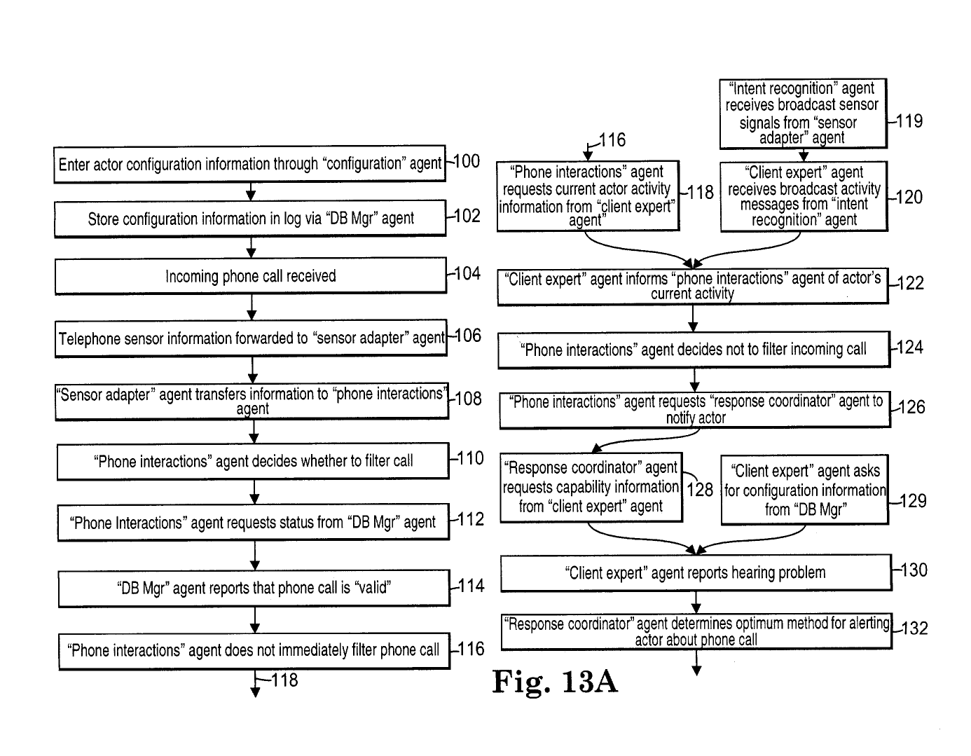

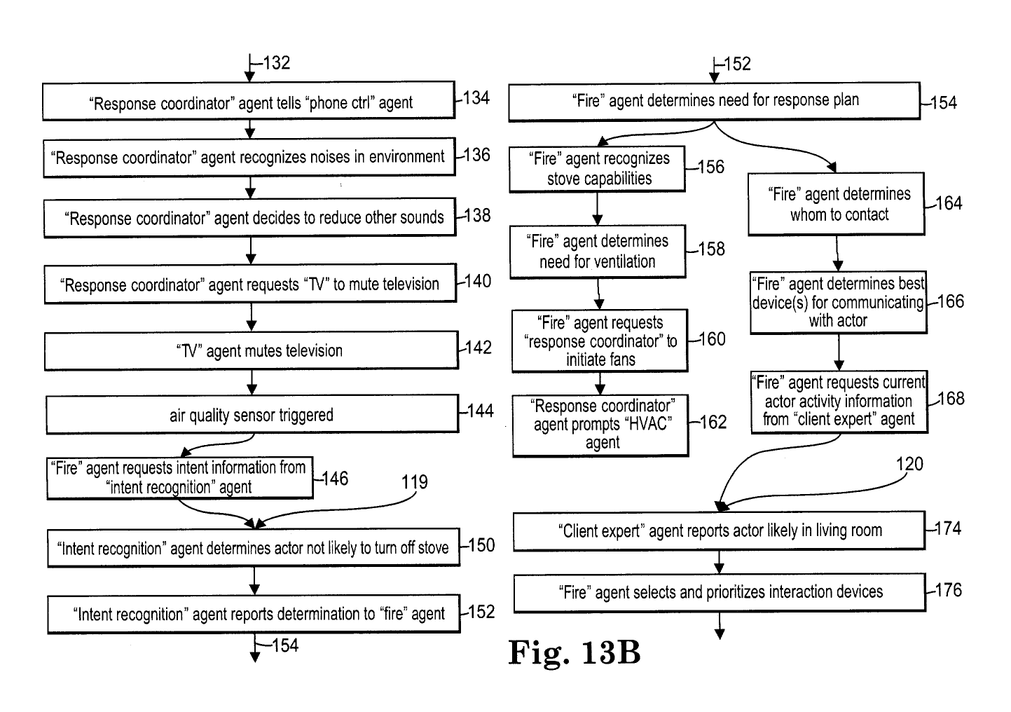

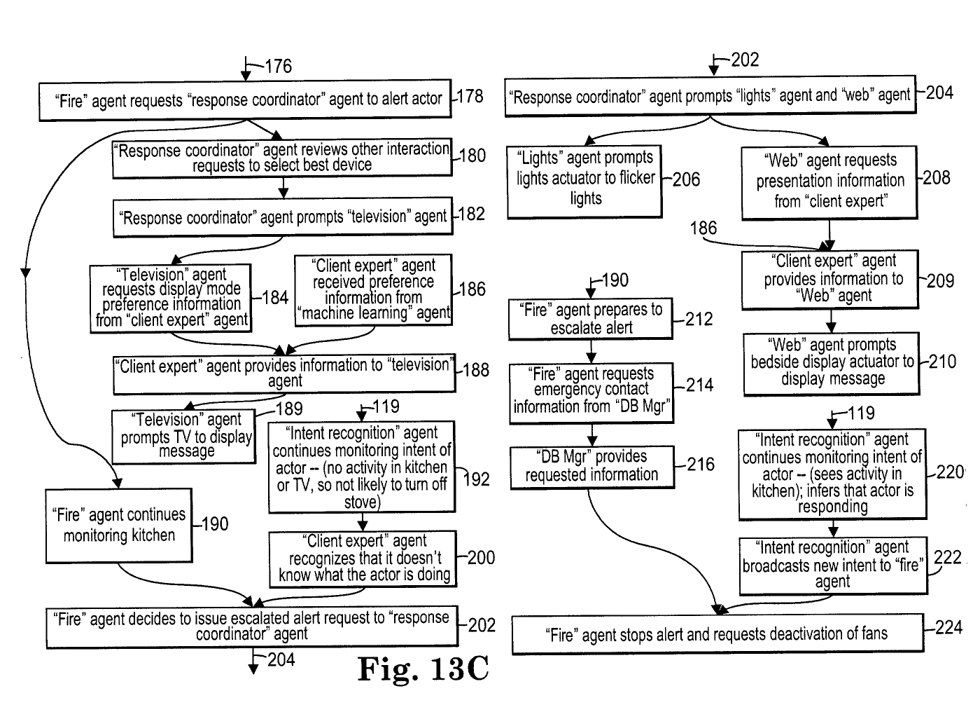

As previously described, the system 20 layered architecture can assume a variety of forms, and can include a variety of agents (or other modules) to effect the desired intelligent environmental automation system with situation awareness and decision-making capabilities, as exemplified by the methodology described with reference to the flow diagram of FIGS. 13A-13C. As a point of reference, the method of FIGS. 13A-13C is preferably performed in conjunction with the architecture of FIG. 14, it being understood that other architectural formats previously described are equally availing. With this in mind, the layered, agent-based architecture of FIG. 14 is applied to an environment including multiple sensors and actuators (as identified in FIG. 14) for an actor living in a home. The exemplary methodology of FIGS. 13A-13C relates to a scenario in which the actor 28 first receives a phone call and then leaves a teakettle unattended on the actor's stove, and assumes a number of situation-specific variables.

Beginning at step 100, following installation of the system 20, an installer uses the “configuration” agent (akin to the “customization” agent in FIG. 3) to input information about the actor, the actor's next-door neighbor, and the actor's home. This information includes capabilities, telephone numbers, relevant alerts, and home lay-out. At step 102, this configuration information is stored in the log via the database manager (or “DB Mgr”) agent.

At step 104, an incoming telephone call is placed to the actor's home. At step 106, a signal from the telephone sensor (that includes a caller identification feature) goes through the “sensor adapter” agent that, at step 108, transfers it to the “phone interactions” agent.

At step 110, the “phone interactions” agent needs to decide whether to filter the call. To this end, the two important factors are (a) who is calling, and (b) what is the actor doing. With this in mind, at step 112, the “phone interactions” agent polls, or otherwise receives information from, the “DB Mgr” agent regarding the status of the incoming telephone number. The “DB Mgr” agent reports that the incoming phone number is the actor's next door neighbor and is thus “valid” at step 114 (as opposed to an unknown number that may be designated as “invalid”). Thus, at step 116, the “phone interactions” agent determines that the call will not be immediately filtered.

Because the “phone interactions” agent has determined that the phone call is from someone of interest to the actor, at step 118, the “phone interactions” agent polls, or otherwise receives information from (e.g., a cached broadcast), the “client expert” agent (or “client” agent of FIG. 3) to determine what activity the actor is currently engaged in. Simultaneous with steps 104-118, the “intent recognition” agent has been receiving broadcast sensor signals from the “sensor adaptor” agent and performing intent recognition processing of the information (referenced generally at step 119). Similarly, the “client expert” agent has been receiving or subscribing to, resultant activity messages from the “intent recognition” agent (referenced generally at step 120). With this in mind, step 122, the “intent recognition” agent informs the “phone interactions” agent that the actor is awake and in the kitchen where a telephone is located.

At step 124, the “phone interactions” agent decides not to filter the incoming call (based upon the above-described analysis). As such, the “phone interactions” agent requests the “response coordinator” agent to enunciate the phone call at step 126. In response to this request, the “response coordinator” agent polls, or otherwise receives information from (e.g., broadcasted information), the “client expert” agent for the actor's capabilities at step 128. The “client expert” agent, in turn, reports a hearing difficulty (from information previously received via the “DB Mgr” agent as indicated at step 129) to the “phone interactions” agent at step 130. At step 132, the “response coordinator” agent determines that visual cues are needed, with additional lights.

With all the above information in hand, and seeing no other requests for interactions and no current alarm state that might otherwise require phone call suppression, the “response coordinator” agent prompts the “PhoneCtrl” agent to let the phone ring and flash lights at step 134. It should be noted that a variety of other incoming call analyses and alerting functions could have been performed depending upon who the phone caller is, where the actor is located and what the actor is doing. Based upon this information, the actor could be alerted in a variety of ways including messages on the television, flashing house lights, or announcing who the caller is via a speaker.

At step 136, the “response coordinator” agent recognizes that other devices or activities in the home may impede the actor's ability to hear the phone ring or the subsequent conversation if the house is too noisy. In light of this determination, the “response coordinator” agent, at step 138, decides to reduce other sounds in the home. For example, at step 140, the “response coordinator” agent prompts the “TV” agent to mute the television. The “TV” agent, in turn, utilizes an IR control signal (akin to a remote control) to mute the television at step 142.

At step 144, an air quality sensor senses smoke near the stove in the kitchen (i.e., is “triggered”), and broadcasts this information to other interested agents, including the domain agent “fire”. In response, the domain agent “fire” polls the “intent recognition” agent as to whether the actor is likely to turn off the stove at step 146. Simultaneous with previous steps, the “intent recognition” agent has received information from the “sensor adaptors” agent (similar to step 119 previously described, with this same step 119 being referenced generally as in conjunction with step 146), and has determined that the actor has previously left the kitchen. With this in mind, the “intent recognition” agent determines, at step 150, that the actor is not likely to turn off the stove immediately, and reports the same to the “fire” agent at step 152. The “fire” agent, at step 154, then determines that a response plan must be generated. In this regard, at step 156, the “fire” agent recognizes that the actor's stove is an older model and does not have a device agent or actuator that could be automatically de-activated, such that a different technique must be employed to turn off the stove.

At step 158, the “fire” agent first determines that ventilation in the kitchen is needed. To implement this response, the “fire” agent, at step 160, requests the “response coordinator” agent to turn on the fans in the kitchen. The “response coordinator” agent, in turn, prompts the “HVAC” agent to activate the kitchen fans at step 162.

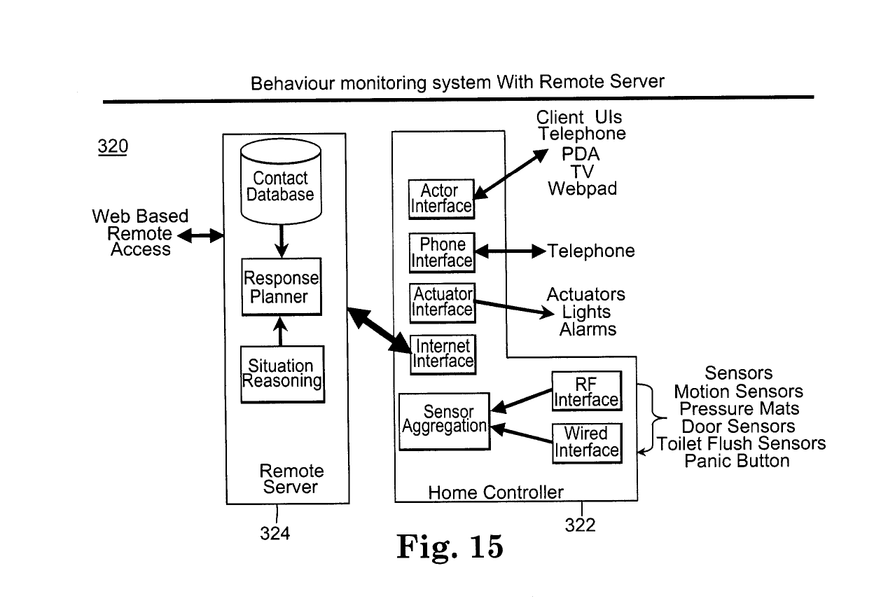

Simultaneous with the ventilation activation described above, the “fire” agent, at step 164, recognizes that the current level of urgency is “low” (i.e., a burning fire has not yet occurred), so that contacting only the actor is appropriate (a higher level of urgency would implicate contacting others). To implement this response plan, the “fire” agent first needs to select an appropriate device(s) for effectuating contact with the actor at step 166. In this regard, all communication devices in the home are appropriate, including the television, the phone, the bedside display, and the lights. The television and the bedside display provide rich visual information, while the phone and the lights draw attention quickly. In order to prioritize these devices, the “fire” agent polls, or otherwise receives information from (e.g., a broadcasted message), the “client expert” agent to determine where the actor is and what the actor is doing at step 168. Simultaneous with the previous steps, the “client expert” agent has been subscribing to activity messages from the “intent recognition” agent, as previously described with respect to step 120 (it being noted that FIG. 15B generally references step 120 in conjunction with step 168). Based on recent device use (i.e., the television remote and power to the television), the “intent recognition” agent, reports to the “client expert” agent (e.g., client expert has cached broadcasts of the actor's activity as determined by the “intent recognition” agent) that the actor is likely in the living room watching television. The “client expert” agent, in turn, reports this information to the “fire” agent at step 174.

With the above information in hand, at step 176 the “fire” agent selects the television as the best interaction device, with the lights and the telephone indicated as also appropriate, and the bedside display eliminated. Pursuant to this determination, the “fire” agent requests the “response coordinator” agent to raise an alert to the actor via one of these prioritized devices at step 178. At step 180, the “response coordinator” agent reviews all other pending interaction requests to select the best overall interaction device. Seeing that there are no other pending interaction requests, the “response coordinator” selects the television as the interaction device for contacting the actor, and prompts the “television” agent to provide the message to the actor at step 182. It should be noted that if other interaction requests are pending, the “response coordinator” agent will preferably select the best combination of interaction devices for all of the pending requests. For example, the “response coordinator” agent can choose a different interaction device for each message, or decide to display/transmit the messages on more than one interaction device.

Returning to the example, in response to the message, the “television” agent polls, or otherwise receives information from (e.g., a cached broadcast message from the “response coordinator” agent) the “client expert” agent as to the best way to present the message at step 184. Prior to this request, the “machine learning” agent has recognized that the actor responds more frequently to visual cues, especially when text is combined with an image. This information has been previously reported to the “client expert” agent, generally represented at step 186. With the learned information in hand, the “client expert” agent informs the “television” agent to present a message on the television screen in the form of “[Actor's name], turn off the stove.”, along with an image of a stove and a burning pan at step 188. The “television” agent prompts the television to display this message at step 189. It should be noted that a wide variety of other message presentation formats could have been selected. For example, if the actor is blind (information gleaned from the “configuration” agent and/or the “machine learning” agent) or asleep (information provided by the “intent recognition” agent), a spoken message would have been more appropriate.

At step 190, the “fire” agent continues to monitor what is happening in the home for combating the smoke/fire in the kitchen. At step 192, the “intent recognition” agent continues to monitor the intent of the actor and determines that the actor has not acknowledged the alert, and that there is no activity in the kitchen (via broadcasted information, or lack thereof, from sensors in the kitchen or at the television, or by polling those sensors). Once again, these determinations are based upon received broadcast sensor signals from the “sensor adaptor” agent as previously described with respect to step 119 (it being noted that reference is made to step 119 in conjunction with step 192). Thus, the “intent recognition” agent generates a reduced confidence that the actor is actually watching television, and moreover the lack of activity in the kitchen means there are no pending high-confidence hypotheses. At step 200, the “client expert” agent receives broadcasted information from, or alternatively requests, the “intent recognition” agent regarding its most likely hypotheses and recognizes that the “intent recognition” agent does not know what the actor is doing. The “client expert” agent reports this to the “fire” agent.

At step 202, the “fire” agent decides, based upon the above information, that the alert level must be escalated and re-issues the alert. In particular, the “fire” agent requests the “response coordinator” to utilize both a high intrusiveness device (lights preferred over the telephone), and an informational device (bedside webpad preferred over the television because there is an ongoing request for the television message, and the television message was found to not be effective). In response to this request, the “response coordinator” at step 204 recognizes that the lights and the bedside webpad do not conflict with one another, and prompts the “lights” agent and the “web” agent to raise the alert.

In response to this request, the “lights” agent flickers the home lights several times at step 206. Simultaneously, at step 208, the “web” agent polls, or otherwise receives information from (e.g., a cached broadcast), the “client expert” agent as to what information to present and how to present it. As previously described, the “client expert” agent has previously been informed (via step 186 as previously described and generally referenced in FIG. 13C in conjunction with step 208) that the actor responds best to combined text with images, and reports the same to the “web” agent at step 209. With this information in hand, the “web” agent prompts the “bedside display” actuator to display the message: “[Actor's name], turn off the stove,” along with an image of a stove and smoking pan at step 210.

Before the actor gets to the stove, the “fire” agent prepares to further escalate the alert at step 212 (following previously-described step 190 in which the “fire” agent continues monitoring the kitchen). In particular, the “fire” agent polls the “DB Mgr” agent as to whom to send an alert to at step 214. The “DB Mgr” agent informs, at step 216, the “fire” agent that the actor's next door neighbor is the appropriate person to contact. However, before the escalated alert plan is effectuated, the “intent recognition” agent is informed of activity in the kitchen, via for example motion sensors data, and infers from this information that the actor is responding to the fire at step 220. Once again, the “intent recognition” agent is continuously receiving signaled information from the “sensor adaptor” agent as previously described with respect to step 119 (with step 119 being generally referenced in FIG. 13C in conjunction with step 220). The “intent recognition” agent reports this change in status to the “fire” agent at step 222 (either directly or as part of a broadcasted message). In response, the “fire” agent, at step 224, does not send the escalated alert, but instead requests that the kitchen fans be deactivated (in a manner similar to that described above with respect to initiating ventilation). Finally, if the “fire” agent determines that the smoke level in the kitchen subsequently increases, the “fire” agent would initiate the escalated alert sequence via the “response coordinator” agent as previously described.

It will be recognized that the above scenario is but one example of how the methodology made available with the system 20 of the present invention can monitor, recognize, support and respond to activities of the actor 28 in daily life. The “facts” associated with the above scenario can be vastly different from application to application; and a multiple of completely different daily encounters can be processed and acted upon in accordance with the present invention.

F. Alternative Controller Hardware Configurations

As previously described with respect to FIG. 1, the controller 22 can be provided in multiple component forms. In this regard, the system 20 architecture combines information from a wide range of sensors and then performs higher level reasoning to determine if a response is needed. FIG. 15 is an exemplary hardware/architecture for an alternative system 320 in accordance with the present invention that includes an in-home processor called the “home controller” 322 and a processor outside the home called the “remote server” 324. The home controller 322 has all of the hardware interfaces to talk to a wide range of devices. The remote server 324 has more processor, memory, and communication resources to do higher level reasoning functions.

The home controller 322 preferably includes a number of different hardware interfaces to talk to a wide range of devices. A client (or actor) interface communicates with devices that the actor uses to interact with the system. These devices could be as simple as a standard telephone or as complex as a web browser enabled device such as a PDA, “WebPad” available from Honeywell International, or other similar devices.

The home controller 322 preferably further includes a telephone interface so that the system 320 can call out in emergency situations. The phone interface can be standard wired or cell based. If enabled to allow incoming calls, this telephone interface can also be used to access the system remotely, for example if a caregiver wanted to check on an actor's status from outside the home using a touch tone phone.

A preferred actuator interface in the home controller talks 322 to devices in the actor's environment that may be controlled by the system 320, such as thermostats, appliance, lights, alarms, etc. The system 320 can use this interface to, for example, turn on a bathroom light when the actor gets up in the middle of the night to go to the bathroom, turn off a stove, control thermostat settings, etc.

Preferred sensor interface(s), such as wired or RF-based, take in information from a wide range of available sensors. These sensors include motion detectors, pressure mats and door sensors that can help the system determine an actor's location and activity level. This interface can also talk to more specialized sensors such as a flush sensor that detects when a client uses the bathroom. An important class of sensors that communicate by without requiring hardwiring are wearable sensors such as panic button pendants or fall sensors. These sensors signal that the actor needs help immediately. Alternatively or in addition, to a number of other sensors, as previously described, can also be implemented.

In one preferred embodiment, the home controller's 322 processor can do some sensor aggregation and reasoning. This low-level reasoning is reactive type reasoning that ties actions closely to sensors. Some of this type of reasoning includes turning on lighting based on motion sensors and calling emergency medical personnel if a panic button is pushed. Most sensor data is passed on to the remote server for higher level reasoning.

The remote server 324 does situational reasoning to determine what is happening in the actor's environment. Situations include everyday activities like eating and sleeping as well as emergency situations, for example if the actor has not gotten out of bed by a certain time of day. A preferred response planner in the remote server 324 then plans a response to the situation if one is required. If the response uses an actuator, a message is preferably sent back to the home controller 322 and out to the device through the actuator interface. If a response requires interaction with the actor, a message is sent to the home controller 322 and routed out through the actor interface.

The remote server 324 preferably further includes contains a database of contact information for responses that require contacting someone. This database includes names, phone numbers, and possible e-mail addresses of people to be contacted and the situations for which they should be contacted.

A single remote server 324 can support a large number of independent environment installations or a large number of individual living environments in an institutional setting. The remote server 324 can provide other web-based services to an actor including, for example, online news services, communications, online shopping, entertainment, linking to other system 320 users as part of a web-based community, etc.

The remote server 324 provides remote access to the system 320 information. Using this preferably web-based interface, caregivers and family members can check on the actor's status from any web-enabled device on the Internet. This interface can also be used when a response plan calls for contacting a family member or caregiver and the actor's contact information says they should be contacted by e-mail. Further interface scenarios preferably incorporated into the system 320 architecture/hardware include allowing information to be pushed or pulled by service providers (e.g., service providers are able to review medical history, repair persons are able to confirm particular brand and model numbers of appliances needing repair, etc.).

The communications between the home controller 322 and the remote server 324 can use regular phone lines or cell phones or it could make use of broadband for high information throughput. Generally speaking, lower bandwidth/throughput requires more processing power in the actor's environment.

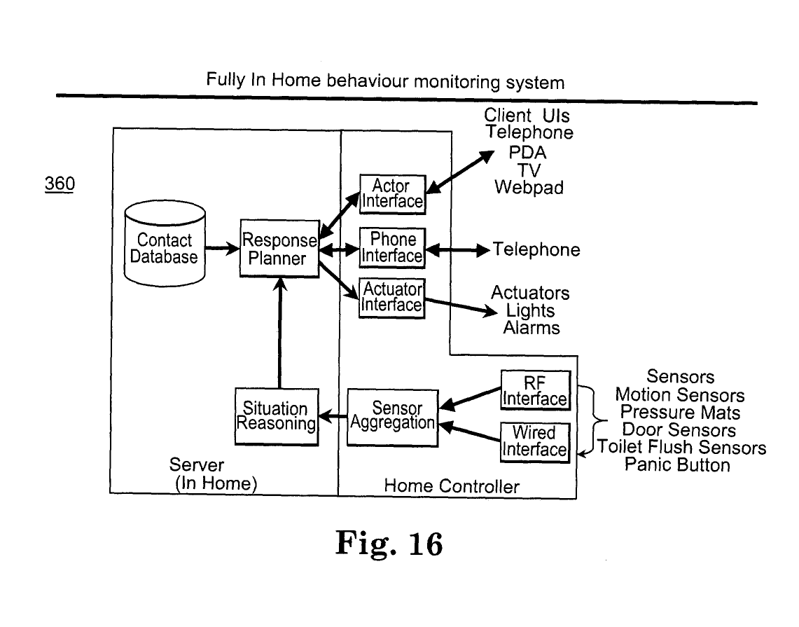

Another alternative hardware architecture 360 configuration, shown in FIG. 16, has the same general functions, but puts all of the processing in the actor's environment. This requires either at least a second processor in the actor's environment to do the higher level reasoning or additional processing and memory resources in the controller at the actor's environment. Either way, the situation assessment and response planning functions are now performed inside the home. Notably, the situation assessment and response planning functions can be performed by separate controllers located in the actor's environment. Regardless, for this architecture, remote access can be accomplished, for example, either through a standard phone interface or by connecting the processor to the Internet.

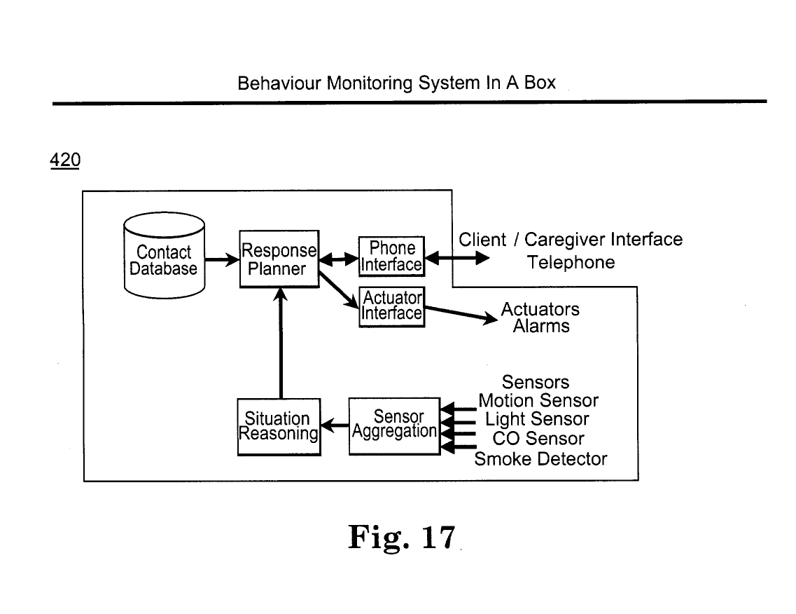

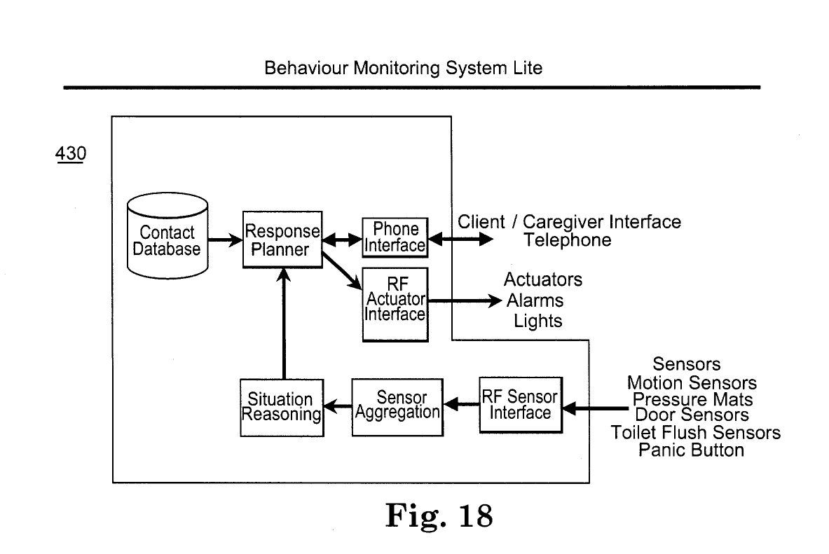

FIG. 17 depicts yet another alternative configuration of a system 420 in accordance with the present invention in the form of a single, self-contained, easily configured, low-cost box. The system 420 combines a small set of sensors and actuators in a single box with a telephone connection (or other mechanism for contacting the outside world). For example, the sensor suite can include a smoke detector, a carbon monoxide detector, a thermometer, and a microphone, while the actuator or effector suite can include a motion-activated light for path lighting, a speaker, and a dial-out connection. With this design, a user (not shown) installs the system 420 so the motion detector can sense the movement of people within the room, indicates what room the device is in, and plugs the device into wall power and phone lines. The system 420 gathers sensor data and periodically relays that data to a server through a dial-up connection. The server can store gathered data from later review by the actor or others such as caregivers. Preferably, the system 420 of FIG. 17 is also capable of on-site reasoning about crises (e.g., panic alert, environmental problems, etc.) and can call caregivers or a monitoring station to alert them of a problem. Thus, the system 420 of FIG. 17 can apply a control signal from the local site (e.g., by asking the actor if he/she is okay, turning on the path light, dialing for help, etc.), and can alter its own behavior based on learning, rather than relying on a remote reasoning. FIG. 18 illustrates yet another, but similar, alternative system 430 configuration in which no “on-board” sensors are provided. Instead, external sensors interface with the system 430 via an RF link. With either of the systems 420, 430, sensors can be provided that are adapted to perform local reasoning (e.g., a video camera that finds moving objects and provides corresponding coordinates and moving vectors).

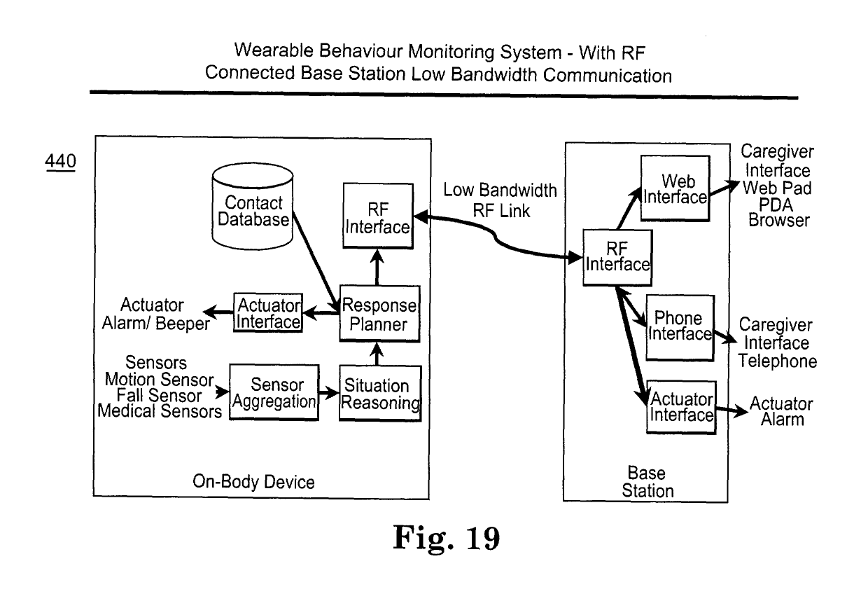

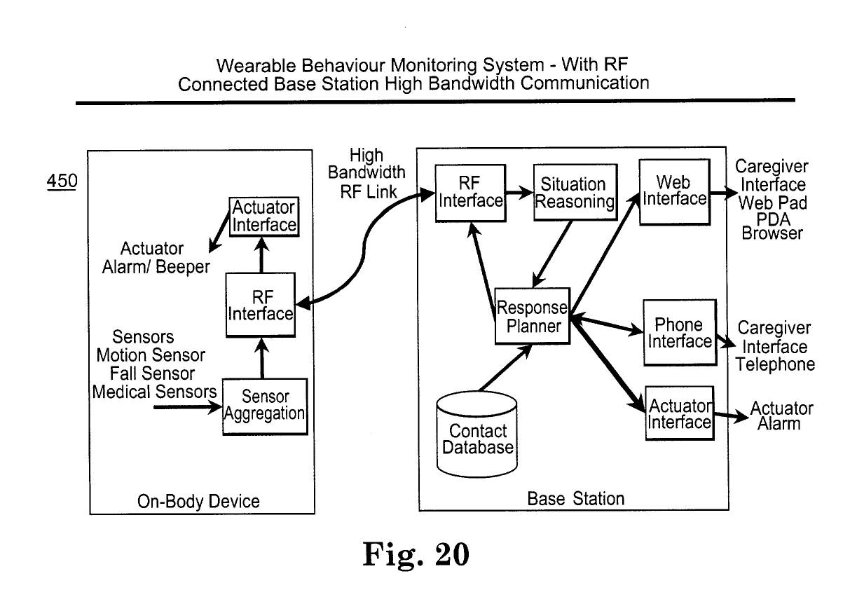

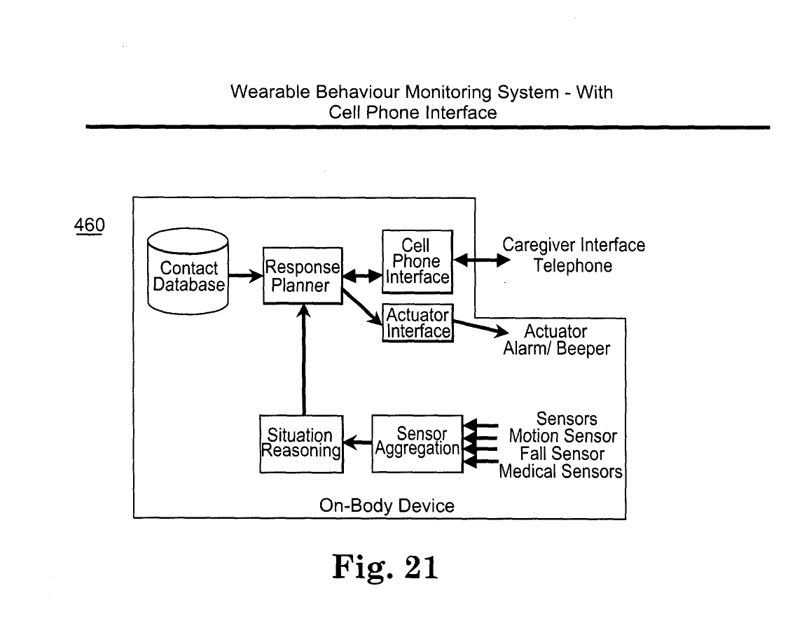

Finally, FIGS. 19-21 illustrates other alternative configurations of system 440, 450, and 460, respectively, in accordance with the present invention in a user-wearable form.

G. Conclusion

In conclusion, the system and related method of operation of the present invention can, unlike any other system previously considered, independently and intelligently monitor, and recognize the behavior of an actor, and preferably further support and respond to the behavior. The preferred system 20 installation includes a controller, sensing components/modules, supportive components/modules, and responsive components/modules. The controller can be one or more processing devices that may be centralized in or out of an area of interest, or distributed in or out of the area of interest. The controller device(s) serve to gather, store and process sensor data and perform the various reasoning algorithms required for determining actor status and needs, generating response plans and executing the response plans via the various actor/effectors an interaction devices available for the actor, the actors environment and/or caregivers. Preferably, the controller further includes data tracking, logging and machine learning algorithms to control and detect trends and individual behavior patterns across collected data. The sensing components/modules include one or more sensors deployed throughout the area of interest in conjunction with related modules for receiving and interpreting sensor data. The supportive components/modules include one or more actuation and control devices in the area of interest. Further, one or more interaction devices, available to the actor and/or the actor's caregiver are provided. To this end, the system and method is preferably capable of using existing interaction devices such as telephones, televisions, pagers, and web-enabled computers. The responsive components/modules include one or more sensors deployed throughout the area of interest, preferably along with actuation, control, and interaction devices.

The system and method of the present invention can provide a number of application-specific features, including (but not limited to) those set forth below:

Safety (Fires, Bums, Poisoning, etc)

Monitor air quality.

Alert actor and caregiver about air quality changes if potential for danger is detected.

Alert Emergency Medical Services (EMS) and caregivers if critical air quality danger exists.

Automatically activate ventilation and air filters (air conditioners).

Automatically shut off source of problem,(e.g., furnace, stove, heater).

Sensor(s) and locks placed on cabinets storing dangerous household chemicals.

Alerting system if unauthorized user opens cabinet.

Detect choking sounds, vomiting or changes in actor's vital signs (such as respirator rate, pulse rate, blood pressure, high/low blood glucose, blood ketones, etc.).

Assess risk to actor and accommodate system's sensitivity to detect fires (e.g., if cigarette smoking is detected near an oxygen device, system would provide a warning).

Monitor heating system, space heaters, fireplaces, chimneys, and appliances (especially stove, oven, toasters, grills, microwaves) and provide alerts if unusual situation occurs.

Diagnostics of electrical wiring, smoke alarm battery, etc., and provide battery replacement reminders.

Provide exit path guidance with signs, lighting, auditory instructions, etc.

Contact caregivers if dangerous situation detected and emergency help if critical situation occurs.

A panic-button-type device that is worn by the actor and can be used to summon help.

Similar to known “smart medicine cabinet”, smart chemical cabinet—that dispenses chemicals for cleaning, etc., carefully.

Medical Monitoring

Monitor bathroom use and combine with other activity information to infer conditions like dehydration, etc.

Communicate with smart medical devices to gather and analyze medical data and make overall health inferences.

Provide initial training, reminders, and/or step-by-step instructions on how to use medical devices.

Provide reminders for actor to use installed medical equipment.

Provide easy method for actors to enter medical information into system for trending and analysis.

Provide easy method that caregiver can enter medical and care information.

Provide caregiver task tracking capability to coordinate efforts of multiple caregivers.

Provide dedicated caregiver information exchange UI facility.

See Eating, Medication, Safety, Mobility, Toileting, Multiple Caregivers, and coordination features issues for additional relevant technology opportunities.

Activity & Functional Assessments

Measurement of the ADL's. Incorporates most of the other functions (notably mobility), but also ability to do laundry, etc.

Visual observation of mobility in the environment. Control of camera to provide a view that would enable assessment of walking, transferring, shaking/reflexes, condition of skin/limbs/arms/legs, etc.

Facilitate administration of functional assessments like the Folstein MiniMental Status, various functional assessment tools used by interviewers.

Functional database for an actor.

Creative questioning and game playing to determine activity engagement, functional status, etc.

Taking measurements (weight, phone use (frequency), water use (to detect bathing), kitchen activities, walking (rate, gait, pause after standing), night activity).

Mobility

Obstacle detection (to warn actor).

Pathway lighting.

Exercise facilitation (regular exercise reduces risk of falling).

Increased monitoring sensitivity based on actor's medical conditions (e.g., if known that actor has had a recent prescription change, increase system sensitivity for fall monitoring).

Increased monitoring sensitivity based on activities or environmental conditions (e.g., seemingly minor everyday stresses, such as postural change, eating a meal, or an acute illness may result in hypotension and therefore, increased risk of falling).

System initiated contacting of medical and/or family members upon a fall.

A panic-button-type device that is worn by the actor and can be used to summon help.

Detect number of people in home.

Track actor's motion, recognize gait, predict problems (obstacles, falls). Recognize changes over time.

Caregiver Burnout

Support remote monitoring of activities and behavior monitor activity levels and environmental parameters.

View video images of actor.

Show trends (activity, appliance use, visitors, phone calls).

Support remote communication that serves as an equivalent surrogate for personal visits (burden and isolation).

Coordinated to-do lists for caregivers.

Daily activity reminders to actor (to keep actor from calling the caregiver).

Daily activity instructions to actor.

Resource guide of elderly-support services (e.g., dinner-delivery, in-home healthcare, or informational web pages).

Customize information content/delivery to caregivers concerns.

Support user-initiated customization of information and contact requests (call/page/email me if recipient does not get up by 8 am on day of some appointment).

Define information that is interesting to the caregivers (e.g. stovetop temperature, front door activity, etc.).

Automatic generation of a caregiver to-do list.

Facilitate caregiver support groups via the internet.

Provide Flexible Access

Leverage automated user interface generation capability (IDS) to deliver content to caregiver across multiple platforms and modalities (PC browser, PDA browser, WAP phone, phone).

Customize user interface presentations according to the actor's capabilities.

Learn user interface effectiveness to adapt presentations in accordance with the actor's preferences.

See also Dementia, medical monitoring.

Medication Management

Provide easy method that actor, caregiver or medical practitioner can update new medications.

Provide easy method that actor, caregiver or medical practitioner can enter medical information.

Provide preprogrammed database of drugs and their possible Adverse Drug Reactions (ADRs).

Provide reminders of time to take drugs, their dosage, and how they should be taken (e.g., with food?).

Provide an automated dispenser to track drugs taken and monitor time taken.

Alert actor and caregiver if new drugs and current drugs will cause ADR, if new drugs are duplicates, if new drug is necessary, if drug duration and dosage are abnormal, if there is better alternative drug (e.g. fewer side effects, less expensive).

Alert caregiver and/or EMS if possible ADR has taken place.

Monitor on-site inventory of medication and automatically re-order, or issue a reminder to re-order, when appropriate.

Cognitive Disorders (Dementia, Depression, etc.)

Task prompts or step-by-step instructions.

Query dialog to ease disorientation or loss of situation awareness (e.g., Actor: Is someone else in the house? System: you are alone in the house).

Monitor activities to detect signs of depression (e.g., sleep patterns, amount of overall activity, changes in appetite, changes in voice).

Administration of standardized instruments for depression assessment (GDS, CDES) or system communicates with caregiver to setup a healthcare professional to administer.

Monitor activities to detect signs of dementia onset or worsening (e.g., forgetting to do things system or others have suggested (STM), forgetting appointments (LTM), Sundowning (see wandering), Hallucinations (see hallucinations)).

Administration of standardized instruments for dementia assessment (RIL, Molloy et al, 1999), or system communicates with caregiver to set-up a healthcare professional to administer.

Assess changes in actor's behavior such as those listed in Kolanowsi, 1994 (e.g., aggressive psychomotor—hitting, kicking, pushing, scratching, assaultiveness).

Increased monitoring sensitivity and/or increased offloading of caregiver responsibilities based on actor's level of dementia (degradation in care recipient is correlated with increased caregiver burden). (Zarit or Montgomery caregiver burden assessment tools).

Education and training about stages of dementia, what to expect, how to handle behavior, resources available, how to reduce stress, etc.

Detect confusion.

Detect agitation.

Trend memory.

Trend toileting.

Eating

Track food for expiration dates and advise resident to dispose of food if too old.

Store basic list of groceries and automatically order new products or add them to an automatic grocery list once the item is used.

Automatically generate shopping list based on meal planning/nutritional goals.

Track nutritional value of meals, and alert caregiver and actor if eating inappropriately.

Monitor food degradation (e.g., if meat has been defrosted in microwave and not cooked immediately, or if meat is out for longer than 2 hours at room temp).

Monitor cooking progress/success (e.g., temperature and time in oven to determine whether food is cooked).

Monitor storage conditions (fridge and freezer temperatures to ensure food is cold enough).

Track schedule of food delivery and alert caregiver/actor/care organization if food delivery does not arrive.

Allow caregiver remote access to actor's shopping list.

Allow for shopping online by the actor or caregiver to alleviate stress or time associated with shopping.

Alert caregiver or actor of store events, sales on merchandise (e.g., coupons, senior specials).

Monitor appliance use, alert and/or control unsafe conditions.

Learn what the actor prefers to eat, and present sample recipes/menus based upon these preferences and other factors such as complexity of preparation as compared to the actor's abilities, what food is available, actor's nutritional needs, etc.

Monitor appliance use.

Suggest menus in keeping with available food, with balanced diet, and within dietary and medication constraints.

Provide instructions on meal preparation.

Transportation

Allow for easy communication with transport services.

Facilitate access to transport schedules.

Alert actor or caregiver if transportation is a problem.

Provide information about local transportation resources.

Isolation

Provide regular interaction with the actor via means that are normally associated with guests, friends, family, etc. (e.g., phone calls and e-mails).

Provide social interaction such as “reading” to actor (i.e., playing books on tape).

Facilitate ways in which actor can continue to get social contact from external sources like video phone interaction with doctors, calling in a daily/weekly shopping list to a human, ordering supplies via phone rather than web, etc.

Create a system community in which all system users can interact with one another via the web, video gatherings, phone.

Show pictures from the familiar past would help positively reinforce the actor and help with social isolation.

Instigate game playing with the actor.

Alert caregiver if the actor is alone for “too long”.

Provide “social” interactions between the system and the actor (e.g., ask social or friendly-type questions and reply to actor's response).

Facilitate on-line shopping.

Con detection (call filtering, door-to-door salespeople).

Managing Money

Electronic banking with automated bill payments and account balancing.

Formation of a bill to-do list to facilitate caregiver who manages finances (e.g., list might include vendors and amounts due along with funds availability information).

Scan phone communications for release of personal info that may indicate response to solicitation.

Monitor credit card bills and check payments for unusual expenditures.

Provide information about local financial management resources.

Checking account interlocks to prevent payments to unauthorized persons or organizations.

Visitor screening to deter door-to-door solicitors.

Support regular social contact to reduce sense of isolation, since isolation is a key reason elders talk to solicitors.

Toileting and Incontinence

Monitor toileting frequency.

Alerts to actor/caregivers.

Reports/Notifications/Reminders to elders/caregivers.

Provide reminders to use the bathroom.

Provide path lighting and obstacle detection for nighttime movement between bedroom and bathroom.

Increased monitoring sensitivity based on actor's medical conditions (e.g., if known that actor has reduced sensation, increase system sensitivity for urination outside bathroom and/or prompts to wear/change diapers).

Reminders and assistance with exercises.

Housework

Detect clutter to suggest clean up.

Detect air quality (look for molds, spores, bacteria).

Remind caregiver or actor to clean.

Detect smells on clothes.

Remind actor or caregiver of washing if not performed regularly.

Provide a washing schedule based on usage of clothes.

Provide information about local housekeeping resources.

Task prompts or step-by-step instructions.

Shopping Assistance

Allow caregiver remote access to actor's shopping list.

Allow for shopping online by the actor or caregiver to alleviate stress or time associated with shopping.

Maintain a schedule for when to go shopping.

Maintain a basic shopping list and track when supplies are low.

Facilitate the development of a shopping list.

Alert caregiver or actor of store events, sales on merchandise, etc.

Pressure Sores

Provide reminders to use bathroom.

Monitor for urine moisture.

Provide reminders to change clothing, wash clothing and sheets if moisture detected.

Monitor position and movement changes.

Provide reminders to change position and suggestions for new positions.

Using Equipment

Omni-directional signal reception (e.g., no matter what way the actor has a selected remote control facing, it will control the proper device).

One-way ergonomic design (a hardware design that makes it clear there is only one way to hold the remote).

Task prompts and cues (keys light up in order as cue for entry sequence).

Voice command controls.

Alcohol Abuse

Fit alcoholic drinks with usage caps that monitor how often they are opened (this is done with certain drug monitoring) and record this information.

Provide sensors for cabinets. Since most people store their alcohol in one area, it can give a rough estimate of how often it is used.

Provide warning messages if actor is has recently used alcohol and is about to take medication.

Provide warnings if consumption is approaching dangerous levels.

Send message via phone or e-mail to caregivers if alcohol misuse is detected (unconsciousness, falls, malnutrition).

Breath tests.

Wandering

Infer OK to leave house (e.g. check actor's schedule before the leave the house).

Interact with actor before they exit to try to “snap them out of it”.

Contact caregiver in the event that the actor is suspected of wandering.

Door mat sensor and door sensor can indicate a potential exit by actor (outside door mat sensor and door bell or acoustic sensor listening for a knock can confirn/disconfirm that the actor is not simply answering the door).

Check actor's schedule to see if exit is expected.

Check behavioral pattern to see if expected or unusual (exiting at 3 am).

If system is sure they are wandering, stall them until a caregiver can arrive.

Inform actor if there is inclement weather; if actor leaves anyway contact caregiver.

If keys are RF-tagged, confirm that actor has keys (if so automatically lock the door; if not, may depend on facial or voice recognition when actor returns to actuate door lock).

Wandering switch—if leaving on purpose, actor actuates a switch at door to indicate leaving house. If not switched, front gate locks to prevent departure and contain wandering path within home territory. Notify caregiver that actor is outside if outdoor conditions are adverse.

Detect & report enter-leave house.

Depression Detection and Intervention

By monitoring actor, especially elder, behavior over time system may be able to detect onset of depression and other user mental states. Changes in sleep patterns, eating patterns, activity level, and even vocal qualities can provide an indication that the actor is becoming depressed. If actor is exhibiting declining trends in any or all of these parameters, system can administer a brief assessment (such as Geriatric Depression Scale coupled with Mini Mental State Exam) via the phone, webpad, or television to confirm the presence of depression. Since social isolation is a common component in elderly, system can also be adapted to intervene by sending a message to a neighbor or friend telling them it may be a good time to stop by for a visit. System can also help by providing wider communications access for the actor, for example connecting the actor with their favorite chat room at the appropriate time.

Some Symptoms of Depression In The Elderly:

Depressed or irritable mood.

Loss of interest or pleasure in daily activities.

Temper, agitation.

Change in appetite, usually a loss of appetite.

Change in weight.

Weight loss (unintentional).

Weight gain (unintentional).

Difficulty sleeping.

Daytime sleepiness.

Difficulty falling asleep or staying asleep (insomnia).

Fatigue (tiredness or weariness).

Difficulty concentrating.

Feelings of worthlessness or sadness.

Memory loss.

Abnormal thoughts, excessive or inappropriate guilt.

Abnormal thoughts about death.

Excessively irresponsible behavior pattern.

Thoughts about suicide.

Plans to commit suicide or actual suicide attempts.

Hallucinations & Delusions

Help actor understand that they are not in any danger then call appropriate parties.

If system detects agitation, then system could ask what is wrong, then system could scan house for signs of an intruder and reassure the actor that there is no one in the house.

Then system can call a designated caregiver party who will intervene to calm the actor.

System can log the event.

Application of Snoezelen Technique

Sensory stimulation technique that has been successful in calming children via multi-sensory stimulation. Indications are that this technique is effective in reducing agitation in those suffering dementia. Application includes: light therapy, essential oils, soft chair, wind chimes, lava lamps, etc. While having a Snoezelen room may not be practical, applying these techniques in part in the room of the agitated actor might be helpful in reducing their agitation until a caregiver can intervene.

Usability

Operational modes (night/day, guests/alone, etc.).

Password-free elder interactions.

Function muting (turn off the toileting stuff today).

Sensor muting (ignore sensor 3 today).

Better display screens—e.g. easy-to-read security panel.

Suggest appropriate attire to the actor before the actor leaves the home.

Sleeping

Track sleeping habits.

Assess current sleeping habits against previous sleeping habits.

Assess sleeping habits based upon recommended sleep traits.

Identify sleep problems.

The present invention provides a marked improvement over previous designs. In particular, the system and method of the present invention incorporate a highly flexible architecture/agent construct that is capable of taking input from a wide variety of sensors in a wide variety of settings, mapping them to a set of events of interest, reasoning about desired responses to those events of interest, and then accomplishing those responses on a wide variety of effectors in a wide variety of settings.

What is claimed is:

1. An automated monitoring and support system for an actor in an environment, the system comprising:
a sensor;
an effector; and
a controller for receiving information from the sensor to monitor at least one of the actor and the environment and for controlling operation of the effector based upon the monitored information, the controller including:
a situation assessor for determining a current situation based upon the sensor information,
a response planner for automatically generating an appropriate current response plan to the current situation as determined by the situation assessor,
a plan executor for prompting the effector to execute the generated current response plan.

2. The system of claim 1, wherein the system includes a plurality of different sensors each providing sensor information to the controller, and further wherein the situation assessor is adapted to selectively evaluate all sensor information.

3. The system of claim 2, wherein the situation assessor is further adapted to aggregate information from at least two of the sensors to designate a single event as occurring.

4. The system of claim 3, wherein the response planner is further adapted to rely upon the designated single event in generating an appropriate response.

5. The system of claim 1, wherein the situation assessor is further adapted to determine the current situation based upon at least one item selected from the group consisting of an activity of the actor, an intended activity of the actor, an inactivity of the actor, the status of the actor, a future status of the actor, a status of the environment, and a future status of the environment.

6. The system of claim 5, wherein the situation assessor is further adapted to consider periods of user inactivity in determining the current situation.

7. The system of claim 1, wherein the response planner is further adapted to coordinate a plurality of possible response plans.

8. The system of claim 7, wherein the response planner is further adapted to prioritize the plurality of possible response plans.

9. The system of claim 1, wherein the system includes a plurality of effectors, and further wherein the response planner is further adapted to select one or more of the plurality of effectors to execute the current response plan.

10. The system of claim 1, wherein the response planner is further adapted to consider previous re-actions of the actor to previous response plans in generating the current response plan.

11. The system of claim 1, wherein the situation assessor and the response planner are further adapted to monitor a response of the actor to the current response plan following execution by the plan executor.

12. The system of claim 1, wherein the system includes a plurality of effectors, and further wherein the plan executor is further adapted to control operations of each of the plurality of effectors.

13. The system of claim 12, wherein the plan executor is adapted to coordinate operation of the plurality of effectors.

14. The system of claim 1, wherein the controller further includes a machine learning device adapted to establish a behavioral model of at least one of the actor and the environment, and further wherein at least one of the situation assessor and the response planner is further adapted to utilize information from the machine learning device in determining the current situation and generating a current response plan, respectively.

15. The system of claim 1, wherein the system includes at least one sensor adapted to provide information relating to the actor and at least one sensor adapted to provide information related to the environment, and further wherein the situation assessor is further adapted to process the actor-related information and the environment-related information.

16. The system of claim 1, wherein the situation assessor, the response planner, and the plan executor are provided as a layered architecture.

17. The system of claim 16, wherein the controller further includes modules adapted to provide protocol constraints relating to designated subject matters, and further wherein the situation assessor, the response planner, and the plan executor define categories of capabilities made available to each of the modules by the controller.

18. The system of claim 17, wherein the controller further includes a first subject matter module and a second subject matter module each adapted to process information within at least one of the architecture layers.

19. The system of claim 18, wherein the first and second subject matter modules are communicatively linked.

20. The system of claim 18, wherein the first subject matter module is adapted to perform situation assessment operations related to a first domain subject matter and the second subject matter module is adapted to perform situation assessment operations relating to a second domain subject matter.

21. The system of claim 20, wherein the first and second subject matter modules are adapted to perform response planning operations relating to the first and second domain subject matters, respectively.

22. The system of claim 21, wherein the controller further includes a plan coordination module adapted to process response plans generated by the first and second subject matter modules.

23. The system of claim 21, wherein the controller further includes an intent recognition module adapted to determine an intent of the user, and further wherein the first and second subject matter modules utilize information generated by the intent recognition module in performing respective situation assessment and response planning operations.

24. The system of claim 21, wherein the controller is adapted to communicatively link a third, newly added domain subject matter module with the first and second subject matter modules.

25. The system of claim 19, wherein the first subject matter module is further adapted to perform response planning operations relating to a first subject matter utilizing information from the second subject matter module.

26. The system of claim 25, wherein the second subject matter module relates to actor information and the first subject matter module is adapted to process information relating to a subject matter selected from the group consisting of fire safety, home security, medication management, telephone interaction, eating, mobility, cognitive disorders, and toileting.

27. An automated monitoring and support system for an actor in an environment, the system comprising:
a sensor located in the environment;
an effector adapted to interface with at least one of the actor and the environment; and
a controller adapted to provide a layered architecture including a sensing layer for receiving information from the sensor, a situation assessment layer for determining a current situation of at least one of the actor and the environment based upon the sensor information, a response planning layer for automatically generating a response plan to the determined situation, and a plan execution layer for prompting the effector to execute the generated response plan, the controller further including:
a first domain subject matter module operating across at least the sensing, situation assessment, and response planning layers, the first domain subject matter module adapted to process information relating to a first subject matter and generate a response plan relating to the first subject matter.

28. The system of claim 27, wherein the first domain subject matter is selected from the group consisting of fire safety, home security, medication management, telephone interaction, eating, mobility, cognitive disorders, and toileting.

29. The system of claim 27, wherein the controller further includes a second domain subject matter module adapted to process information relating to a second subject matter and generate a response plan relating to the second subject matter.

30. The system of claim 29, wherein the controller further includes a plan coordination module for prioritizing response plans generated by the first and second domain subject matter modules.

31. The system of claim 27, wherein the controller further includes a second subject matter module adapted to process information relating to a second subject matter, and further wherein the first domain subject matter module utilizes information from the second subject matter module in performing situation assessment operations relating to the first subject matter.

32. The system of claim 27, wherein the controller further includes a second subject matter module adapted to process information relating to a second subject matter and further wherein the first domain subject matter utilizes information from the second subject matter module in performing response planning operations relating to the first subject matter.

33. The system of claim 27, wherein the controller further includes an intent recognition module adapted to recognize an intended activity of the actor based upon sensor information, and further wherein the first domain subject matter module utilizes information from the intent recognition module in performing situation assessment operations relating to the first subject matter.

34. The system of claim 27, wherein the controller further includes an intent recognition module adapted to recognize an intended activity of the actor based upon sensor information, and further wherein the first domain subject matter module utilizes information from the intent recognition module in performing response planning operations relating to the first subject matter.

35. The system of claim 27, wherein the controller further includes a behavioral database that establishes a behavioral model for at least one of the actor and the environment, and further wherein the first domain subject matter module utilizes information from the behavioral database in performing situation assessment operations relating to the first subject matter.

36. The system of claim 35, wherein the controller further includes a machine learning module adapted to generate the behavioral database.

37. The system of claim 27, wherein the controller further includes a behavioral database that establishes a behavioral model for at least one of the actor and the environment, and further wherein the first domain subject matter module utilizes information from the behavioral database in performing response planning operations relating to the first subject matter.

38. The system of claim 37, wherein the controller further includes a machine learning module adapted to generate the behavioral database.

39. The system of claim 27, wherein the system further includes a plurality of sensors, and further wherein the controller includes an event recognition module adapted to aggregate information from multiple ones of the sensors to designate a single event as occurring, and further wherein the first domain subject matter module utilizes information from the event recognition module in performing situation assessment operations relating to the first subject matter.

40. The system of claim 27, wherein the system further includes a plurality of effectors adapted to interface with the actor, and further wherein the controller includes a plan coordination module for implementing the response plan via at least two of the effectors.

41. An automated monitoring and support system for an actor in an environment, the system comprising:
a plurality of sensors adapted to sense information relating to the actor and the environment;
a plurality of effectors adapted to interface with the actor; and
a controller adapted to provide a layered architecture including a sensing layer for receiving information from the plurality of sensors, a situation assessment layer for determining a current situation of at least one of the actor and the environment based upon the sensor information, a response planning layer for automatically generating a response plan to the determined situation, and a plan executing layer for prompting at least one of the effectors to execute the generated response plan, the controller further including:
the first domain subject matter module operating across at least the sensing, situation assessment and response planning layers, the first domain subject matter module adapted to process information relating to a first subject matter and generate a response plan relating to the first subject matter,
a second domain subject matter module operating across at least the sensing, situation assessment, and response planning layers, the second domain subject matter module adapted to process information and generate a response plan relating to a second subject matter,
a third domain subject matter module operating across at least the situation assessment layer and adapted to process information relating to the actor,
a fourth subject matter module operating across at least the situation assessment module and adapted to process information relating to the environment,
a response execution module adapted to process response plans generated by the first and second domain subject matter modules.

42. The system of claim 41, further comprising a machine learning module communicatively linked to at least one of the first, second, third, and fourth modules.

43. The system of claim 41, further comprising an intent recognition module communicatively linked to at least one of the first, second, third, and fourth modules.

44. The system of claim 41, wherein the controller is adapted to load and communicatively link additional subject matter modules.

45. A method of automatically monitoring and supporting an actor in an environment, the method comprising:
receiving information from a plurality of sensors located in the environment;
automatically assessing a situation relating to at least one of the actor and the environment based upon information from the plurality of sensors;
automatically generating a response plan based upon the assessed situation; and
automatically executing the response plan by operating at least one of a plurality of effectors in the environment.

46. The method of claim 45, wherein automatically assessing a situation includes automatically assessing a situation of a plurality of subject matters.

47. The method of claim 45, further comprising:
providing a plurality of subject matter modules each adapted to assess a situation of a different subject matter.

48. The method of claim 47, wherein at least one of the plurality of subject matter modules utilizes information from at least another one of the plurality of subject matter modules in assessing a situation of the corresponding subject matter.

49. The method of claim 45, wherein automatically assessing a situation relating to the actor or the environment includes determining an intent of the actor.

50. The method of claim 45, wherein automatically generating a response plan includes generating a plurality of response plans relating to a plurality of different subject matters.

51. The method of claim 50, further comprising:
providing a plurality of subject matter modules each adapted to generate a response plan relating to a different subject matter.

52. The method of claim 50, further comprising:
evaluating each of the plurality of response plans; and
designating a primary response plan based upon the evaluation.

53. The method of claim 45, wherein generating a response plan includes referring to a machine learning database.

54. The method of claim 53, wherein generating a response plan further includes:
adapting the response plan to capabilities of the actor as provided by the machine learning database.

55. The method of claim 45, further comprising:
monitoring a response of the actor to the response plan following execution of the response plan.
